(19) United States
(12) Patent Application Publication
(10) Pub. No.: US 2015/0007307 A1
(43) Pub. Date: Jan. 1, 2015

(54) Method and System for Integration of Instruction and Task Completion Based Access to Mobile Device Operating Systems

(71) Applicant: eBravium, Inc., Reno, NV (US)

(72) Inventors: Patrick M. Grimes, Reno, NV (US); Linda S. Grimes, Reno, NV (US); Cody M. Grimes, Reno, NV (US)

(21) Appl. No.: 14/488,839

(22) Filed: Sep. 17, 2014

Related U.S. Application Data
(63) Continuation-in-part of application No. 14/203,405, filed on Mar. 10, 2014.
Application No. 14/203,405 is a continuation-in-part of application No. 14/203,418, filed on Mar. 10, 2014.
Application No. 14/203,418 is a continuation-in-part of application No. 14/207,261, filed on Mar. 12, 2014.
Application No. 14/207,261 is a continuation-in-part of application No. 14/213,928, filed on Mar. 14, 2014.
(60) Provisional application No. 61/879,138, filed on Sep. 18, 2013.
(60) Provisional application No. 61/778,988, filed on Mar. 13, 2013.
(60) Provisional application No. 61/775,623, filed on Mar. 10, 2013.
(60) Provisional application No. 61/777,178, filed on Mar. 12, 2013.
(60) Provisional application No. 61/782,006, filed on Mar. 14, 2013.

(51) Int. Cl. H04L 29/06; H04W 4/02; H04W 12/08; H04W 4/14

(52) U.S. Cl. CPC H04L 63/083; H04W 4/14; H04W 4/023; H04W 12/08
USPC 726/18

(57) ABSTRACT

Networked based methods for remotely locking and unlocking designated features on a user's electronic computing device (e.g. internet, games, SMS, email) while keeping other software functioning for the user to perform selected activities (e.g. quizzes). Unlocking the device may be based upon a condition, such as the user achieving an objective (e.g. answered quiz questions, received a high class grade, etc.), or the passage of time (e.g. duration of a test), or detecting the device GPS coordinates. The device may be locked/unlocked remotely via a gateway server communicating via a network with the device, or directly via a passcode utilizing a software module loaded on the device. The lock may be overridden, such as in emergency situations to allow the user to call 911 or their emergency contacts, wherein a third party is electronically notified; or, unlocked by the user with the passcode when a selected activity is successfully completed.

### PRIORITY CLAIM

This application claims priority to Provisional U.S. Ser. No. 61/879,138, filed Sep. 17, 2013.

This application is also a continuation-in-part of and claims priority to U.S. Ser. No. 14/203,405 filed Mar. 10, 2014 which claims priority to Provisional U.S. Patent Application Ser. No. 61/778,988 filed Mar. 13, 2013.

This application is also a continuation-in-part of and claims priority to U.S. Ser. No. 14/203,418, filed Mar. 10, 2014 which claims priority to Provisional Ser. No. 61/775,623 filed Mar. 10, 2013.

This application is also a continuation-in-part of and claims priority to U.S. Ser. No. 14/207,261, filed Mar. 12, 2014 which claims priority to Provisional Ser. No. 61/777,178 filed Mar. 12, 2013.

This application is also a continuation-in-part of and claims priority to U.S. Ser. No. 14/213,928, filed Mar. 14, 2014 which claims priority to Provisional Ser. No. 61/782,006, filed Mar. 14, 2013.

The entire contents of the aforementioned applications are hereby directly incorporated in by reference.

### FIELD OF THE INVENTION

The present invention relates to control of access to a mobile computing and/or communication device by a third party who requires the user to accomplish specific instructional based objectives or other tasks in order to use the device.

### BACKGROUND OF THE INVENTION

With the explosion of new computer and mobile applications (i.e. apps) that can disguise and hide the ultimate purpose of a given electronic computing device's software application, a third-party such as a parent, needs help in controlling or monitoring the computer and mobile applications used by their children that facilitate the use of social media. For example, a parent might restrict the SMS (text message) function of a mobile phone by blocking the use of such an application through the network provider during specific periods of time. However, a mobile phone that has had the SMS function blocked by the network provider can still be connected to the Internet providing the child with the ability to download one of several alternative services (or mobile applications) that enable SMS, such as the SMS service on AOL. In other words, the parent could contract with the network provider of the phone service to block the SMS function during school hours. However, if the child has an Internet or cellular connection on their electronic computing device, s/he can still SMS by accessing another feature offered through the Internet or wireless community. Accordingly, a parent (or other 3^{rd} party) can only guarantee compliance with a stated objective at the initial access step of the electronic computing device. In other words, if a parent intends to influence the use of certain features (or apps of an electronic computing device) by their child, then the parent's most defendable control is the initial setup portion of the security access for the electronic device. In this regard, the third-party (e.g. parent) would establish a system where the target end user (e.g. child), gains access to the electronic device in exchange for completion of education-based material.

Manufacturers of electronic computing devices such as laptop and desktop personal computers, smartphones, cell phones, smart televisions, gaming devices, and tablets already provide a security access process system. In some cases options of security control strategies are available, such as slide lock, security number, security letters, combinations, etc. However, all of these strategies are generally intended to ensure that someone other than the targeted user of the electronic device is denied access and none of them (parental control oriented locking strategies) are designed to create a motivational or inspiring set of conditions or circumstances upon which a targeted user is driven by the desire to access the “addictive” features of the electronic device (such as social media, games and those with the operating loop) in exchange for demonstrating a learning or satisfactory completion of an instruction.

The various embodiments disclosed herein provide for integration of a security system designed to block and limit the use of the electronic computing device by the target user (e.g. child), until s/he accomplishes specific education based objectives as controlled by a third party, such as a parent, teacher or employer into devices utilizing the existing Mobile Device Operating Systems such as that provided by Android, Jelly Bean, Ice Cream Sandwich, etc., iOS 5, 6, 7, Microsoft mobile windows and others including adaptions of the same such as the operating systems for the Kindle products offered by Amazon.

The various embodiments disclosed herein address the inherent limitations of many of the parental control features that are designed to literally “lock” a child into a single app or feature of the phone. In most cases the “lock” is only “unlocked” by a passcode generated which is created by the administrator or in some cases the elapse of time. The intent of these designs is to enable a parent or teacher to “lock” their child into a particular education app so they can't depart the targeted app and enjoy another feature or app. An additional design feature enables the administrator to provide access to a strictly entertainment app like a game or social networking only for a fixed period of time. Those familiar with the art will recognize such features being provided by Apple's Guided Access and Kindle's Kindle Free Time by way of examples whereby the developers of parental control features have taken different technical positions. For example, Apple's Guided Access locks the targeted user into an app until an administrative passcode is used to “unlock”. Amazon's Kindle, on the other hand, uses its Kindle Free Time to lock the targeted user into an app until a specific time is achieved and then the entire device is locked. However reaching in direction, none of the existing parental controls enable the targeted user of the electronic device to gain or earn their access out of a particular app or gain access into a particular app by conducting a learning, education or instructional series of measurable commands. Further, systems that require an administrator passcode force the administrator to be physically involved to release the targeted user from the “locked” app. In other words, if a parent has to use his personal passcode or select the passcode each event, the parent is placed in a burdensome position. What is needed is a system that can be integrated into existing parental controls that provides a session specific passcode (generated by either the operating system or the specific app itself) that the administrator sets and then once targeted learning (or instruction) is achieved within the targeted application, the session specific passcode is generated. Thusly, enabling the targeted user to freely use the other features of the electronic device without the need to burden the parent (or administrator).

### SUMMARY OF THE INVENTION

Various embodiments disclosed herein have application in the field of education and training. They provide computer implemented systems, methods, and electronic computing devices comprising computer program products for optimizing a student's academic performance by customizing education sessions to maximize the amount of dopamine and other stimulants released into the student's central nervous system and brain in relation to a reward (e.g. Brain Reward Center Stimulation or “BRCS”). The amount of dopamine and other stimulants released directly relates to a student's response to a reward offered as part of participating in the learning/testing session, and in particular: 1) the type of reward trigger (e.g. achieving a milestone, demonstrating effort, and random rewards); 2) the timing of the learning objective relative to the reward; and, 3) the nature of the reward (time to use device, cash, store credit or coupon or discount).

According to some embodiments, a number of security options exist to block electronic transmissions from a computing device in order to, for example, protect the device from being used inappropriately. Methods known by the skilled artisan that may be used in the various embodiments comprise those used in the following scenarios: 1) use by unauthorized person; 2) use at an unsafe time; 3) use to explore “inappropriate” applications; and, 4) use to abuse “appropriate” applications.

In the case of (1) use by an unauthorized person, a personalized “security passcode” is typically generated through the smart device's operating system through the “settings” widget under security. The passcode can be numbers, letters, patterns, movement or combinations. This passcode is designed to protect the smart device from use by an unauthorized person such as a thief, but it can also include a curious or “snoopy” friend. The security passcode demonstrates what one familiar with the art could do to disable access to the smart device for periods of time that include until a target event occurs or the passage of a prescribed amount of time.

In the case of (2) use at an unsafe time, an optional setting is typically provided through the smart device's operating system through the “settings” widget airplane mode. This airplane mode is designed terminate radio communications that could interfere with the airplane communications. Examples of the specific services terminated include phone service, SMS services, email, WIFI, GPS, and Bluetooth. The “airplane mode” demonstrates what one familiar with the art could do to disable each of the individual radio communication devices or any combination for periods of time that include until a target event occurs or the passage of a prescribed amount of time.

In the case of (3) use to abuse appropriate applications, access to a setting can be provided by the smart devices operating system through “settings” widget and in other cases a separate native application is required. Examples of options under settings are Guided Access from iOS 6 while options from native applications include Ap Lock and Kids Place. In addition, software packages for operating systems for smart devices like laptops, computers, etc. include “parental guidance” as a standard feature component of their operating system. The objective of these particular features is to prevent unauthorized or unintended use of specific applications of the smart device. In one case a parent may not want his child to download entertainment applications such as Angry Birds or social applications such as Instagram while in another example a boyfriend may not want his girlfriend to read his SMS history. The “guided access”, “parental controls” and the “native applications” demonstrate what one familiar with the art of blocking, restricting, etc. the use of a smart devices particular applications for periods of time that include until a target event occurs or the passage of a prescribed amount of time.

In the case of (4) use to abuse appropriate applications, access to the operating system separate native application is typically required. Examples of options include “parental control” software packages for operating systems for smart devices like laptops, computers, etc. as well as native applications such as MMGuardian and software packages known as “spyware” such as that offered by Mobistealth. The objective of these particular features is generally to either block or restrict access for period of time, to track the activity of the user such as emails or text messages of the specific websites visited, complete or part of emails or text messages and screening such as referring to a list of blocked websites that could for example contain adult themed material. In one case a parent may not want his son to send inappropriate pictures from his smart device to his son's girlfriend while in another example an employer may want to ensure that his employee is not engaged in personal Facebook social messaging when he should be investigating marketing data from Facebook. The “parental controls” and the “native applications” demonstrate what one familiar with the art of blocking, restricting, monitoring, etc. the use of a smart device's particular applications for periods of time that include until a target event occurs or the passage of a prescribed amount of time.

Separately, in the case of tracking GPS coordinates many smart devices including devices utilizing the iOS operating system, have a built-in GPS function. The GPS function is a byproduct of using a smart device. For example, the built-in receiver trilaterates one's position using data from at least three GPS satellites and the receiver. GPS can determine one's location by performing a calculation based on the intersection point of overlapping spheres determined by the satellites and your phone's GPS receiver. In simple terms, trilateration uses the distance between the satellites and the receiver to create overlapping “spheres” that intersect in a circle. The intersection is one's location on the ground. This GPS feature has been incorporated into a number of native applications and web based applications that incorporate the smart devices user's location. Examples include: Groupon, Facebook Nearby, Event Seeker, DRIVING APPS. (i.e. mobile apps that for example turn off text messaging features when an electronic device detects certain speeds and motions similar to driving conditions). In each of these examples, the smart device user can be informed when s/he enters a specific set of coordinates about a particular discount at restaurant, a friend's proximity or a an entertainment event. The “GPS coordinates” demonstrates what one familiar with the art could do to enable the smart device to become a tracking beacon for periods of time that include until a target event occurs or the passage of a prescribed amount of time.

### BRIEF DESCRIPTION OF THE DRAWINGS

The above and other features, aspects, and advantages of various embodiments of the present disclosure will become better understood with regard to the following description, appended claims, and accompanying drawings as applied in the embodiments to devices using the iOS operating system where:

FIG. 1 is a schematic diagram of the three functions of a gateway, reward, and assessment.

FIG. 2A is a diagram illustration of an instant override features that enable an automatic by-pass for emergencies and third-party by-pass features of the locked electronic device.

FIG. 2B is a flowchart diagram of computer steps illustrating an example process of the system locking the user device, and then overriding the lock, such as in an emergency.

FIG. 3 is a schematic diagram of a client-system architecture with a database storing records of user's optimal learning methods based on an assessment done via the system.

FIG. 4 is a schematic diagram of an electronic computing device (e.g. smart device) with the modules of the computer program product installed.

FIG. 5A describes one possible configuration of the disclosure where a computing device such as a smart device has an unlock application which controls access to computing device.

FIG. 5B is a flowchart diagram of computer steps illustrating an example process of the system locking the user device, and then unlocking the device based upon a condition.

FIG. 6 is a block diagram describing various methods of locking an electronic computing device.

FIG. 7 is an illustration of a synchronization example wherein a description of one possible configuration is provided of how the synchronizing of multiple devices could be achieved so that an individual with access to multiple devices is forced to engage with the target learning content as if he were accessing the target learning from the same device.

FIG. 8 is a diagram illustration of a retail reward of end user based on performance.

FIG. 9 is a diagram illustration of multiple content providers and a system for their introducing said content to retail reward contest.

FIG. 10 is a diagram illustration of a random generation of passcode using operating system application blocking system from the administrator's perspective.

FIG. 11 is a further diagram illustration of random generation of passcode using operating system application blocking system from administrator's perspective.

FIG. 12 is a diagram illustration of the end user's experience in unlocking the operating system application from within a learning application.

FIG. 13 is a flowchart of computer steps illustrating an example for locking and unlocking designated features on the user device using a randomly generated passcode.

### DETAILED DESCRIPTION

### Glossary of terms

As used herein, the term “Administrator” refers to the entity that controls access to the electronic computing device. The administrator may be the third party, or the administrator may be affiliated with the system server who controls the access to the device via a network after being provide permission to do so by the third party and/or the user.

As used herein, the term “Electronic Computing Device” or “Electronic Device” refers to any electronic device comprising a central processing unit (i.e. processor) with the ability to transmit and receive electronic communications comprising via Internet and/or cellular connectivity, such as: laptops, desktops, tablets, iPads®, iPods®, smartphones, cell phones, personal digital assistant devices, game consoles, computerized toys and robots, a media player, wearable smart devices, and any combination of two or more of these devices. The Internet and/or cellular connectivity is controlled by a “network provider” such as Verizon®, AT&T®, etc. It also includes digital televisions, smart televisions such as those from Samsung and Apple, as well as gaming devices such as Xbox 360® by Microsoft and PlayStation 3® by Sony.

As used herein, the term “Gateway Function” refers to functions that enable the use of a selected feature on an electronic computing device contingent on correctly responding to one or more educational queries. The gateway to a device may be controlled by different methods/entities, comprising: 1) software modules on the electronic computing device that block the user of the device until academic requirements (e.g. quiz blocking access to SMS); 2) network providers—e.g. the Internet or cellular service provider, who utilize software on a system server to block access to a user's account/device until academic requirements are met; and, 3) automated education module providers (e.g. school system software posting grades online) that block access to a student's device until grades are achieved.

As used herein, the term “Reward-based Function” refers to the individual's choice of what type of reward they will receive for completing a learning module, comprising: cash, retailer redemption debit card or coupon, access to electronic computing device (e.g. smartphone), access to particular website (Facebook) or software (e.g. video game).

As used herein, the term “Learning Assessment Function” refers to the present disclosure's method of analyzing an individual's optimized learning routine. The system and method determine how best a student learns (e.g. textbooks versus lecture) and how best they test (e.g. true/false versus essay questions).

As used herein, the term “User” and “End User” refers to the person (e.g. student) whose electronic computing device is being controlled.

As used herein, the term “Monitor”, refers to the entity who is supervising the educational progress of the user (in the absence of a person engaging in educational self-improvement of their own volition). For example, a monitor may be a parent, an employer, a coach, etc.

As used herein, the term “Performance Parameter(s)” refers to the specific objectives the user must accomplish to receive the reward. The parameters may comprise a wide variety of tasks, such as academic grades, attendance, conduct, etc.

As used herein, the term “A System” may be used to claim all aspects of the present disclosure wherein it refers to the entire configuration of hardware and software in all embodiments. In a preferred embodiment, the “system” comprises a user computing device with Internet connectivity (e.g. laptops, tablets, smartphones, “smart” car systems such as those offered by Ford's SYNCH program, etc.). In an alternative embodiment of the present disclosure, the system comprises a client-server architecture comprising a user computing device with Internet connectivity, such as laptops, tablets, and smartphones, to communicate with a system server via a network, wherein the software of the present disclosure is installed on the system server and electronically communicates with the user's device over the Internet. Furthermore, as may be the case in combination with a Comprehensive System of Integrated Education (or by itself) the user's computing device may have modules of the present disclosure installed to assist in the user's testing. Furthermore, the user's computing device may have modules of the present disclosure installed to assist in the student's learning exercise and redemption of a reward for completing the exercise, and/or to enable remote controlled access to the device by a network provider, retailer, or CIES vendor. The system may also comprise: the system server (e.g. CIES) communicating via the Internet with Retailers' computer system servers, and/or the Network Providers' system servers, and/or the Monitor's electronic computing device. In another embodiment, the Network Provider and the System Server (e.g. CIES) are one in the same, such as a network provider that offers the service of blocking user's devices. In this embodiment, the monitor contracts directly with the network provider rather than with a CIES provider/vendor. And in another embodiment, the Retailer System Server and the CIES System Server may be one in the same. For example, a monitor may authorize a retailer, such as Apple®, to control access to the user's smartphone bought via an Apple® vendor.

As used herein the term “Client” computer or computing device refers to any user, third party, and administrator electronic computing device capable of communicating with a remote server via the Internet such as a tablet (e.g. Kindle®, Nook®, iPad®), smartphone, hand-held “palm top” computer, laptop computer, desktop computer, terminal, PDA (Personal Digital Assistant), PIM (Personal Information Manager), Network computer, wireless communicator (such as a cellular or satellite telephone), a multi-User computing system or wearable smart device. The user's client electronic computing device, or client device, may also comprise an interactive robot and/or an interactive toy.

As used herein the term “Server” or “Gateway Server” refers to any computing device that stores and runs the Educational software and database storing records of a user's history and profile, and reports provided to the 3^{rd} Parties. To the extent, rewards are offered the server would include the system by which rewards are offered and include combinations. The server system also facilitates the collection and distribution of content to and from a multiplicity of client computers and may incorporate academic information generated by a user's school from education software companies like Blackboard® and Edline® or custom content by teachers, parents, employers, rehabilitation specialists, etc.

As used herein, the term “Software” refers to computer program instructions adapted for execution by a hardware element, such as a processor, wherein the instruction comprise commands that when executed cause the processor to perform a corresponding set of commands. The software may be written or coded using a programming language, and stored using any type of non-transitory computer-readable media or machine-readable media well known in the art. Examples of software in the present disclosure comprise any software components, programs, applications, computer programs, application programs, system programs, machine programs, and operating system software. For purposes of this disclosure, instructional material and instructional software is considered the same as education material and education software in so far as an instruction can be to complete a question among other actions like move an arm or run a specific distance. The reference to education content and learning are a convenient and relevant example of the disclosures applicability but should not be considered a restriction of the intent of the disclosure.

As used herein, the term “Module” refers to a portion of a computer program or software that carries out a specific function that may be used alone or combined with other algorithms of the same program. In a preferred embodiment, the module is an education module comprising questions of a specific subject matter, or content, and of increasing complexity.

As used herein, the term “Pattern Recognition Learning” refers to the ability to learn new information by a simple examination of new material. An example might be a student who memorizes the multiplication table but does not understand the relationships of the numbers. Specifically, a student might know that 7 times 6 is 42 but they may not understand the relationship of numbers.

As used herein, the term “Cognitive Learning” refers to the ability to learn new information by an analysis and detailed examination of new material. An example might be a student doesn't memorize the multiplication table but understands the relationships of numbers. Specifically, a student might not know 6 times 7 is 42 but if he knows that if you add (7+7+7+7+7+7) or (6+6+6+6+6+6+6) a correct answer will be achieved.

As used herein, the term “Feature” refers to user functions comprising a computer program installed on the electronic computer device, and/or a computer function normally associated with a particular type of device. For example, a smartphone or cell phone has a functionality of Internet access, SMS and MMS messaging, and may have a variety of mobile applications, or programs, installed in the device's memory by the user.

As used herein, the term “Third Party” refers to the entity that is being provided information by the system server regarding the user's test performance. For example, a third party may be a parent, an employer, a coach, etc.

### Overview of Gateway, Rewards and Assessment

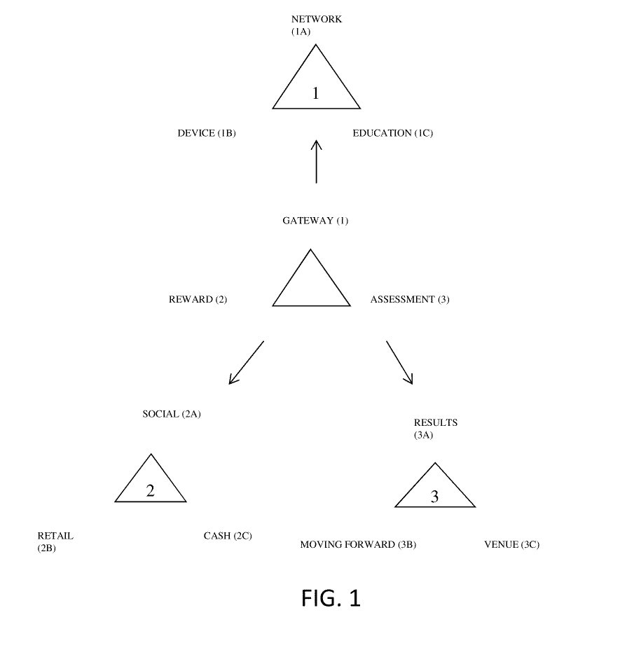

An overview of present disclosure is more easily understood by referring to the schematic diagram of FIG. 1, which illustrates a Comprehensive Integrated Education System (CIES). At the center of the CIES is a multiple-triangular relationship between a gateway function (1), a reward-based function (2) and a learning assessment function (3).

Within the gateway function (1) is a further triangular relationship between network providers (1A), electronic computing devices (1B), and automated education providers (1C). Within the reward-based function (2) is a further triangular relationship between social media (2A), retail (2B) and cash (2C). Within the learning assessment function (3) is a further triangular relationship between educational results (3A), education venues (3C) and strategies moving forward (3B).

The Gateway Function comprises network providers as illustrated in FIG. 1, 1A, which comprise commercial entities providing services to wireless and digital electronic computing devices, such as Horizon, Vodaphone, AT&T, Verizon, etc. The Network providers serve an important role of providing specific services to the end users (e.g. children/students) under a range of financial arrangements from pay as you go to fixed monthly payments. The software that they utilize may include apps written at the native, web and cloud levels (including combinations).

Electronic computing devices (FIG. 1, 1B) comprise software and hardware manufacturers for personal computer devices such as cellular phones, smart phones, electronic tablets, laptops, desk tops, interactive televisions, etc. A non-limiting example of device manufacturers comprise: Dell, Toshiba, Hewlett Packard, Apple, etc. The electronic computing devices serve the important role as providing end users with a range of functional options ranging from text messaging, to internet browsing, etc. The software that they utilize may include apps written at the native, web and cloud levels (including combinations).

Automated education providers (FIG. 1, 1C) include systems such as Learning Community Management Systems from Edline and companies like K12, Inc. The automated education providers serve an important role of working with education institutions such as public, private and charter schools along with groups of home schooled children to provide an automated and accessible platform providing current and relevant academic performance through the Internet, or other communication network. Many employers are using cloud-based training platforms such as MindFlash and Knoodle (Knoodle is no longer in operation, does this need to be changes). These third-parties allow remote preparation of training material by the employer as well as remote review and testing by employees.

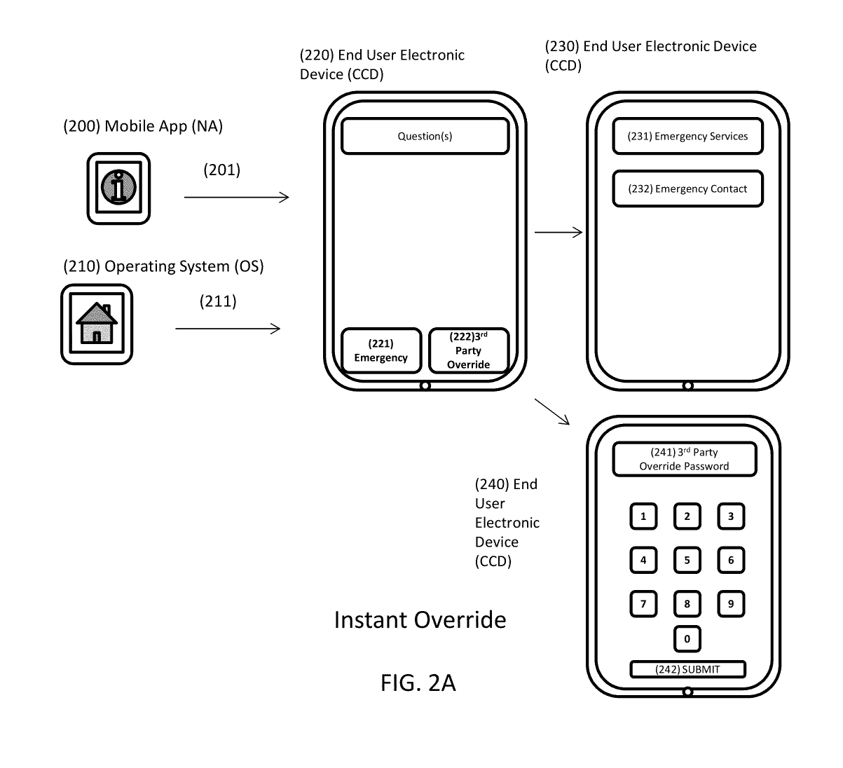

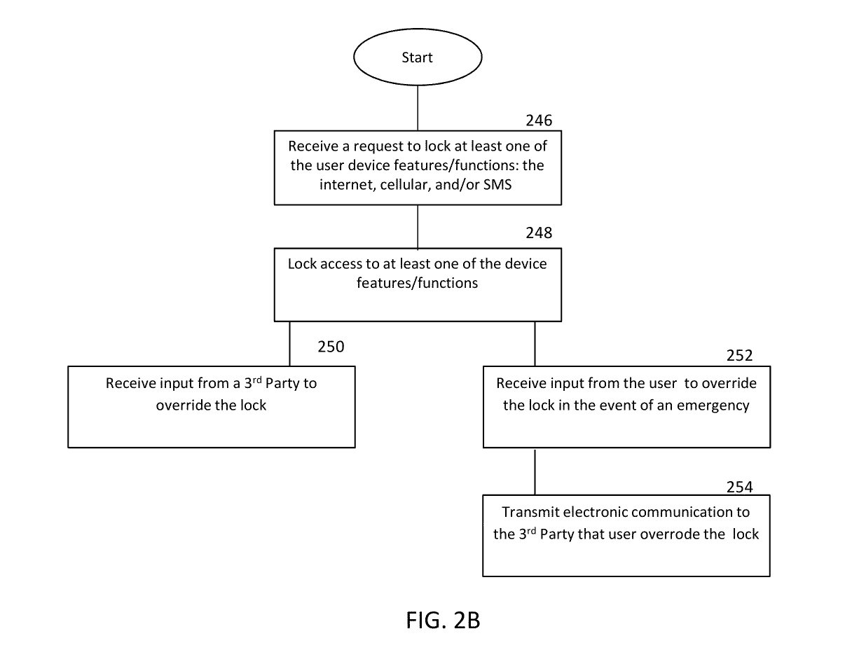

The Reward Function as pertaining to FIGS. 1 and 2A-C, comprises social media providers (2A) with a wide range of personal connectivity options, such as Facebook, LinkedIn, Match.com, Skype, instant messaging, inter-active gaming, like 4 Dimensions and Avalon, texting, etc. The social media providers serve an important role of providing an intoxicating and seductive platform for social interactions under different compensation arrangements from free, fee-for-service to fixed monthly plans. Retailer providers (2B) with prepaid cards, or coupons that are given to the student as a reward for successfully completing a learning exercise comprise a diverse range of outlets with physical locations or online shopping, such as Starbucks Gold Card, eGift, Walmart, Macy's, BestBuy, etc. The retailer providers serve another important role of providing a range of electronic payment types. Retail can also include on-line downloads such as iTunes or mobile apps from Apple Store or Google Play Store. Cash (2C) is available in traditional forms from banks or anyplace with an ATM or on-line services such as PayPal or Amazon Coins. Redeemable coupons, debit cards, pre-paid credit cards are also earning recognition comparable to cash.

The Learning Assessment Function as illustrated in FIG. 1, 3A-C comprises the educational results (grading feedback) that include the measured results earned by the user's academic performance, such as percentage, a numerical grade, etc. The educational results are typically tabulated in a range of methods from student written essay, multiple choice, true false, completed in handwriting, scantron forms and combinations of the same. Educational venues (method of learning) include an analysis of the measured results by among other things cognitive and pattern recognition testing and evaluation. Educations venue serve an important feature in evaluating learning patterns that identify strengths and deficiencies. Education strategies (working with results) moving forward essentially include the concepts of electing to improve on the observed strengths, or to improve on the observed weaknesses or a combination. In other words, an action plan for personalized learning is developed after an analysis of the results.

### Analysis of Test Results

The Learning Assessment Function may further comprise Educational software, and/or any other entity derived testing and education software (e.g. SAT practice test questions software), that is stored on the system server of CIES, the school system, and/or the educational software contractor to the school system. If functions to analyze the user's academic performance in school and/or from the testing modules operational on the user's electronic computing device, a multitude of types of analyses can be performed on the user's test data, such as the following, and any combinations thereof:
The user's time to provide answer to a question. This information can help identify trends such as high aptitude areas as well as weaknesses in certain question taking strategies (such as not reading all the answers provided to look for the best answer choice).
Trends to the time of day can help identify periods of the day where a user performs at higher and lower intellectual intensity.
Results from different core subjects compared together can be a useful tool in identifying learning trends based on interest. For example, a user performs well in math, art and science but not geography could suggest the person is not engaged.
Results for cognitive versus pattern recognition can surface brain development differences leading to new education strategies.
Results of how a user learns new information in terms of audio, visual and reading can lead to invaluable tools for enhanced learning.
Results of native knowledge, such as general understanding of physics and geography, compared with school knowledge such as chemistry, are compared to the background information provided to the person taking the question so as to provide a more accurate evaluation of the performance of the user.
Results of question types, such as multiple choice, true/false and fill-in-the-blank, can reveal test taking strategies rather than academic subject weaknesses.
Trends of the day, week or month for optimal user testing performance can be helpful in assisting a user in scheduling their academic workload and standardized testing.
Trends related to age can demonstrate correlations with maturity.
Trends related to social activities may require isolation to confirm suspicions about trends of distractions. In particular, understanding the SMS activity or social networking activity before, during and after a session could reveal disturbing trends of social distractions.
Trends related to school test dates can be conducted with a simple interface with a student's calendar. Revealing anxiety the day before a scheduled test can create opportunity for subtle time management changes.
Trends of a user compared to those of his class, school, school district, state, etc. in a particular field of study can be of great value. For example, if the questions within the Q&A system database were generated by a school district a user could know at any particular time his competence compared to his peers.
Trends compared to results for similar subjects in a classroom could help reveal teaching/learning conflicts. For example, if the analyses showed that a user performs well on all math test questions, but not well on similar subjects in school one can investigate the cause for the difference.
Trends compared to results obtained from aptitude tests such as SAT, MCAT, GMAT.

### Emergency & Instant Override Features

The blocking feature of the present disclosure may also be overridden at any time by the user in an emergency situation. By inputting in a preset code into the device, the user can gain limited access to the device to place an emergency call (e.g. VoIP to emergency responders or to the third party associated with their account on the system server); or to gain access to email, text, instant messaging, or the like functionality on the device for transmission of electronic communications to designated contacts. The user's record stored on the database of the Multi-Layered Education Lock server will comprise a list of designated emergency contacts and their electronic communications addresses (e.g. mobile numbers for calls or texts, email addresses, etc.). The code for overriding the device block may be a personal code designated by the user and stored in their account on the system server, or it may be a universal code for all users of the system. The code may also be input into the device via keystroke, touch input to a touch screen, or audio input. Additionally, every instance of the user's implementation of the emergency override is recorded in their system record and electronically conveyed instantly to the third party affiliated with the user's record.

FIG. 2 illustrates two instant override features that are possible components of the disclosure. In each case, the override provides for by-pass to the learning modules so that the device can be used for emergency contacts or the device can be used by the third-party or parent in such a manner that he is not forced to answer the education content.

In the first instance, FIG. 2 describes a general emergency override feature (221), but those well-known in the art will understand multiple alternatives are available. The emergency override feature (221) is either downloaded from the NA (201) or from the OS (211) or both to the electronic device such as smart phone (220). The emergency feature (231) provides the end user to select from two further options from a user interface such as (230). Option one is the emergency services (231) which connects the user to the local authorities such as fire or police or 911. Option two is the emergency contacts feature (242) which allows the user to select and contact a predetermined emergency contact (232) list such as parents, friends. This emergency override system connects to emergency services that are offered by the various network providers for smart phones, such as ATT on a standard basis.

In the second instance, FIG. 2A describes the 3^{rd} party override feature (222) but those well-known in the art will understand multiple alternatives are available, and FIG. 2B is a flowchart diagram illustrating an example process of locking the user device, and then overriding the lock. The 3^{rd} party override feature (222) is either downloaded from the NA (201) or from the OS (211) or both to the electronic device such as smart phone (220). The 3^{rd} party override feature (222) provides a 3^{rd} party user access to a user interface such as (240) to enter a custom four digit pass code (241) and submit the pass code (242) from the electronic device (240) to its normal functionality. For instance, a parent shares an electronic device with his child and wants to use the phone without answering questions to unlock the electronic device. In this case, the parent would select the 3^{rd} party override (222) enter the known four digit pass code (241) and then submit the answer (242). The override features represent an important aspect of the disclosure in the case of an urgent need for access to the electronic device. In an alternative case, the target user may have his/her own override option such as the one for the third-party override. In such a case, it would be important to ensure that at the same time the end user implements his own override that a message in the form of a SMS or email is concurrently sent to the third party.

Per the flowchart of FIG. 2B, at step 246 the system (e.g. the gateway system) receives a request to lock the user electronic device to prevent the user from using the electronic device in any capacity, or from using certain designated functions on the electronic device, such as Internet, cellular phone calls, email, instant messaging, text messaging, and selected software installed on the device (e.g. games). In step 248, the system locks the electronic device as per the request. This can be done remotely via the gateway system, or via the OS (211) or NA (201) that is installed on the device. In step 250, a 3^{rd} party may override the lock, such as by entering a pre-designated code. In step 252, the user may manually unlock their electronic device, such as by entering a pre-designated code. In step 254, the 3^{rd} party is notified by electronic transmissions (such as email, SMS, etc.) whenever the user manually overrides the lock.

### Computer Program Product

The present disclosure may further comprise a computer program product downloaded or pre-installed on the device such as a mobile app on the user's and 3^{rd} party's electronic computing device (e.g. smartphone, tablet, etc.) or included as a component of the device's operating system. The Instructional software and the computer program product may also comprise a cloud version and/or a hybrid version that uses cloud computing and conventional servers.

The computer program product (“App”) of the present disclosure may comprise a native application, a web application, or a widget type application to carry out the methods of graphically displaying the age (i.e. the duration since the last viewing) of content on a computing device screen. In a preferred embodiment, a native application is installed on the device, wherein it is either pre-installed on the device or it is downloaded from the Internet. It may be written in a language to run on a variety of different types of devices; or it may be written in a device-specific computer programming language for a specific type of device. For example Android relies on APK (android application package files) files whereas Apple relies on iOS files. In another embodiment, a web application resides on the system server and is accessed via the network (or cloud). It performs basically all the same tasks as a native application, usually by downloading part of the application to the device for local processing each time it is used. The web application software is written as Web pages in HTML and CSS or other language serving the same purpose, with the interactive parts in JavaScript or other language serving the same purpose. Or the application can comprise a widget as a packaged/downloadable/installable web application; making it more like a traditional application than a web application; but like a web application uses HTML/CSS/JavaScript and access to the Internet.

### System Architecture

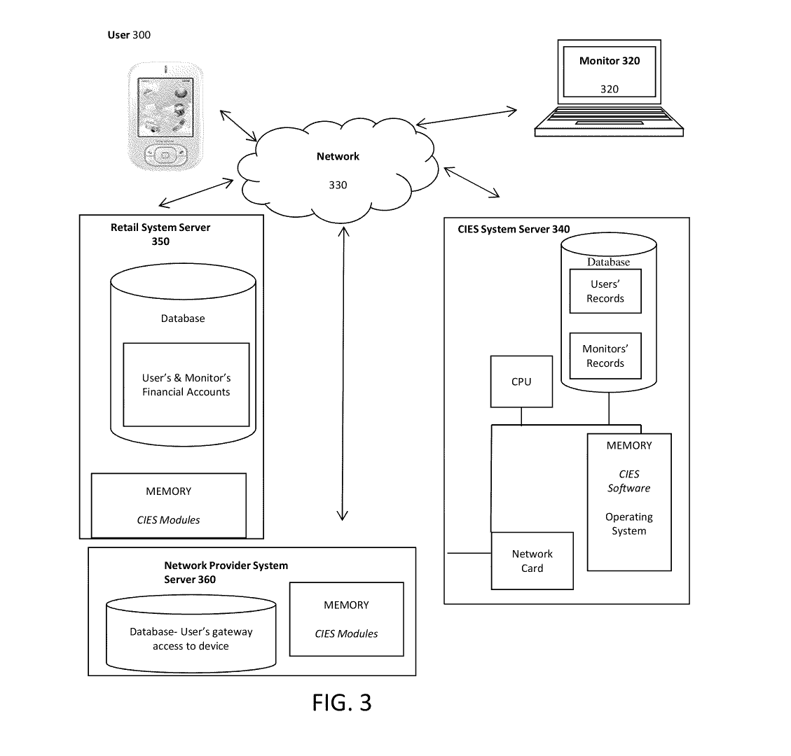

As illustrated in FIG. 3, the general system architecture of the present disclosure, such if utilizing cloud or web based mobile applications, comprises the following: 1) the one or more User's Client System 300 (e.g. student's smartphone); 2) one or more Monitor's Client System 320 (e.g. parent's laptop); 3) the Network (e.g. Internet) 330; 4) the CIES System Server 340. The system may further comprise one or more Retailer's System Server 350 (e.g. Starbucks®); and/or one or more Cellular/Internet Network Provider System Server 360 (e.g. Verizon).

The “Network” comprises any public network such as the Internet or World Wide Web, or any public or private network as may be developed in the future, which provides a similar service as the present Internet. A Client System 300 is a User's electronic communications device with web browser capabilities (e.g., laptop, smartphone, etc. . . . ) configured to communicate with the System Server 340 via the Network 330, in order to receive and respond to educational/testing modules, or the modules may be loaded into the memory of device 300. Likewise, the Monitor's System 320 is an electronic computing device with web browser capabilities (e.g., laptop, smartphone, etc. . . . ) configured to communicate with the User's System 300, or with the System Server 340, via the Network 330. Maintaining flexible connectivity is important given that service can be interrupted. For example, a preferred system will include the ability to enable a user to continue the learning exercise on a “disconnected” device so they can continue the learning process independent of connectivity. The User's and Monitor's System may connect to the network via a variety of methods such as a phone modem, wireless (cellular, satellite, microwave, infrared, radio, etc.) network, Local Area Network (LAN), Wide Area Network (WAN), or any such means as necessary to communicate to a server computer connected directly or indirectly to the Network.

In alternative embodiments of the disclosure, the User's System 300 and the Monitor's System 320 are one in the same electronic computing device with the CIES modules of the present disclosure installed thereon. The CIES modules enable the monitor to select and/or review the activity of the user in practicing the CIES educational modules. In one preferred embodiment, the monitor's access to the CIES modules is protected by a security feature (e.g. login credentials) to permit the monitor to select which educational modules for the user to practice and the approved solutions (e.g. answers) for the modules.

The CIES System Server 340 comprises: a network card or other device for connecting to the Network 330; a Memory unit comprising random access memory (RAM) for program execution, flash memory, and hard disc drive and storing the Comprehensive Integrated Education System (CIES) software of the present disclosure; a central processing unit (CPU) executing the educational modules or grade reporting feature; and a system database storing records of the User's and Monitor's Account Activity. Records may comprise, for example: the User's date, time, and GPS location when practicing a particular educational module; grade performance as transmitted by a school online grade reporting system; reports on assessment of user's optimal learning environments and test questions (e.g. multiple choice, T/F). It is also noted that in addition to the CIES software of the present disclosure, third party software may be stored on the system server 340 that assesses the user's optimal academic performance (e.g. evaluations of user's performance on stored school tests or standardized tests (SAT), user's areas of strengths, weaknesses, etc.) (See FIG. 1, Assessment (3)). Additionally, the CIES System Server 340 may be part of a larger network, such as the Network provider's system server (e.g. ATT, Verizon, etc.) (see FIG. 1, 1-A)); or CIES modules of the present disclosure may be stored on the Network Provider's System Server 360 and communicate with the main server 340.

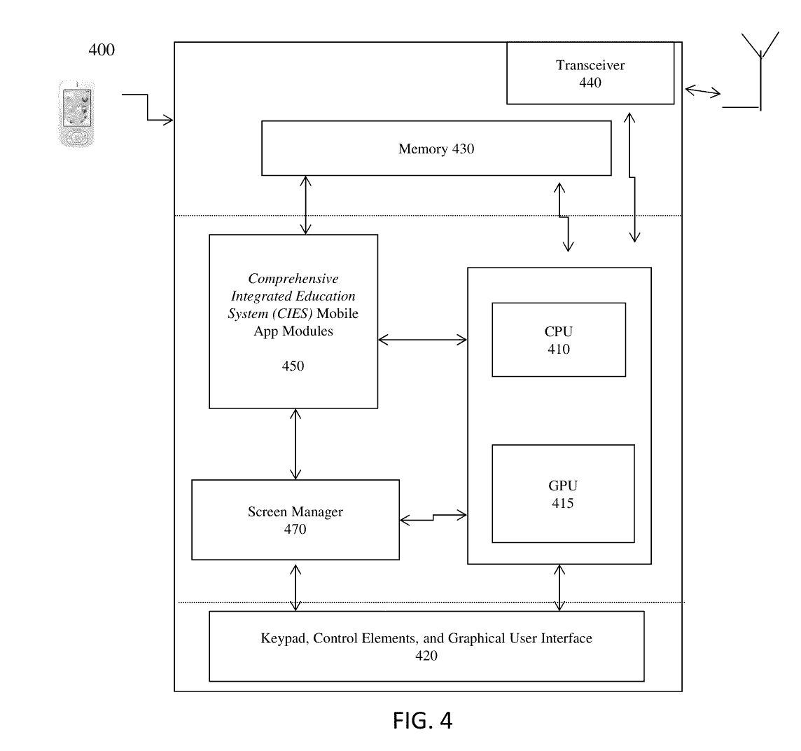

The User's client system 300 comprises CIES mobile app modules to enable the user to practice the CIES test/educational modules (see also FIG. 4, 450); and/or to enable the device to be remotely blocked by for example the network provider. Successful completion of the module permits the CIES System Server 340 or the user's Network Provider 360 to unblock: the entire device 300, and/or particular features of 300 (e.g. Internet access or texting capabilities) if the user has selected device access as their reward (e.g. FIG. 1, Social (2-A)). Methods of blocking electronic computing devices by network providers are well known in the art (See section “Blocking Electronic Computing Devices”). For example, AT&T® offers parental controls such as AT&T Smart Controls® that block individual functions and groups of functions. With AT&T parental controls, certain periods of time can be blocked as to prevent a child from texting during school hours for example.

If the user has elected to receive cash and/or deposits to their credit or debit cards from the monitor, the user's device 300 will communicate successful completion of the educational module directly with the monitor's system 320 via the network (Internet) 330, or via the CIES System Server 340 (e.g. the server would send an email/text to the monitor's device 320 notifying them of the reward due). The same could be accomplished by using PayPal or Amazon Coins for example.

If the user has elected to receive discounts/coupons/credits from a retailer that is funded by the monitor, the user's device 300 will communicate successful completion of the educational module to the Retailer's System Server 350, wherein funds will be transferred from the monitor's financial account to the user's financial account stored on the server 350. The same could be accomplished by using Starbucks® Card eGift for example.

On the other hand, if the user has elected to receive discount/coupons/credits from the retailer that is funded by the retailer, such as in collaboration with a school educational system incentive program for rewarding good grades, then the school online system (e.g. CIES System Server 340) will notify the Retailer System Server 350 to reward the user. Likewise, the school online system (e.g. CIES System Server 340) will notify the Network Provider System Server 360 to unblock a user's electronic computing device as a reward for the user's academic performance. Alternatively, the same could be accomplished by downloading the reward directly to the user 300 whereby an electronic coupon or credit can be fed directly to the cash register. This is similar to how coffees are purchased as Starbucks or airline tickets are processed on mobile devices for a paperless transaction.

### Example of End User Device in System Architecture

As illustrated in FIG. 4, the system architecture for the exemplified user's mobile device 400 with Internet capacity (e.g. a smartphone) comprising: an internal telephone microphone/speaker; a central processing unit (CPU) 410; a graphical processing unit (GPU) 415; a User interface with touchscreen data input keypad or keyboard or keys 420; memory 430 such as random access memory (RAM), read only memory (ROM), nonvolatile memory such as EPROM or EEROM, flash memory or hard drive memory; a transceiver 440 functionally connected to an antenna to receive and transmit data in a wireless network; and Comprehensive Integrated Education System Mobile App Modules 450 of the present disclosure stored on an additional internal memory chip. The transceiver may operate according to standards commonly known in the art by the skilled practitioner, such as for GSM, GPRS, wireless local and personal area network standards, and Bluetooth.

GPU 415 comprises a graphics rendering module configured to perform various tasks related to calculating and displaying the screen images. Screen manager 470 with a software or firmware process that manages content displayed on the GUI 420. The screen manager monitors and controls the physical location and type and appearance of content data displayed on the GUI 420. The screen manager also reveals the various native, web, cloud and combinations through the display of widgets.

The electronic computing devices further comprise hardware/software for Internet connectivity to receive emails, SMS texts, chat messages, and engage in VoIP conversations. The devices comprise Enhanced Data Rate for Global Evolution (EDGE), 3G, and/or 4G data transfer capabilities.

### Blocking Electronic Computing Devices

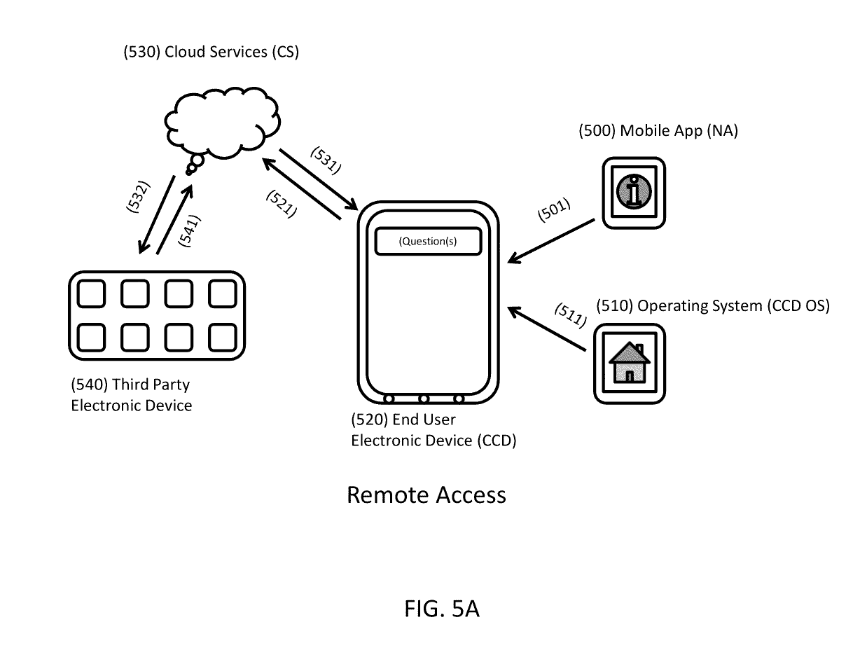

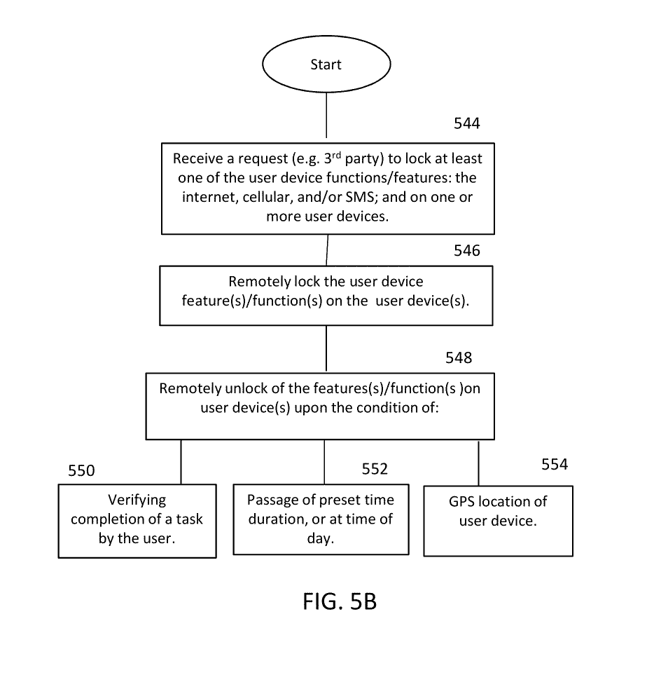

FIG. 5A describes one possible configuration of various embodiments where a device such as a smartphone has an unlock app (either NA or CCD OS) which controls access to the device (CCD); and FIG. 5B is a flowchart diagram illustrating an example process of the system locking the user device, and then unlocking the device based upon a condition.

The unlock app contacts cloud services (CS) which instructs it whether or not the device can currently only be unlocked via correct interaction with educational content, and then displays that content to a user of the device (CCD). If the user properly interacts with the content (such as giving a correct answer to a question), the unlock app terminates its function and surrenders control of the device to the user.

The various embodiments may contain two main components, a native application (NA) 500, and cloud services (CS) 530. The NA runs on a cloud-connected client device (CCD) 520 and can be described as an unlock or login app that allows or restricts access to the rest of the device's functionality. Alternatively, the functionality delivered in the NA could be programmed directly into the CCD's operating system 510. The NA is activated 501 whenever the device is powered up, restarted, or comes out of sleep mode. (If a device has just entered sleep mode, the NA may allow instant access without challenge, if the last time the device was accessed was within a certain period of time.) The NA immediately contacts CS web services 521 via internet connection enabled by WiFi or Carrier Data Plan, using a URL which resolves thereto. The NA receives back from the CS 531 a payload of information in a data packet in a common data interchange format such as XML or JSON, which contains educational content (EC) and an unlock status code (USC), which one familiar with the art would know is content within the cloud (CS) 530. The USC may instruct the NA that the device is (a) unlockable, (b) freely unlockable, (c) unlockable after appropriate interaction with educational content, or (d) other conditional possibilities. If access to the device is conditional {i.e., (c) or (d)}, the NA will present a User Interface (UI) which will prompt the user to correctly interact with it in order to unlock the device. If the interaction is correct, the NA terminates after allowing full access to the device's operating system's main user interface for accessing the device's functionality. If the interaction is incorrect, the NA will process certain logical conditions which may allow second chances to interact correctly with educational content, optionally after a certain wait period, and/or allow visual and/or auditory access to learning content prior to answering again, and/or give second chances at new content, or completely block access, or other logical possibilities.

In some implementations of the various embodiments, the content and/or conditions of unlocking and/or restrictions and/or conditions and/or rewards given for correct interaction, may be accessed from other third party internet connected devices 540 via a secure app or web-portal, which enables authorized users to specify content, restrictions, rewards, and so on the CS (collectively “establishing the unlocking criteria”) 541. In the case of the FIG. 5A, the CS is accessed by separate and distinct cloud-connected instructor device 540.

In one example to further illustrate FIG. 5A, a parent uses their third party device 540 to make a request to-thrrough the cloud server 530 for their child to answer a math question such as 4×4 thru 541, the cloud server then sends requested answer to the child's electronic device 531 thru 541. Once the answer is input onto the device 520 by the child, the input is processed from or by the child's electronic device 520, and the information is sent back to the cloud server 530 thru 521. The cloud server 530 will then send the answer back to the third party device 540, in this case identified as the parent, thru 532 which then tells the parent the answer. The server 530 may also indicate if the answer is correct or incorrect.

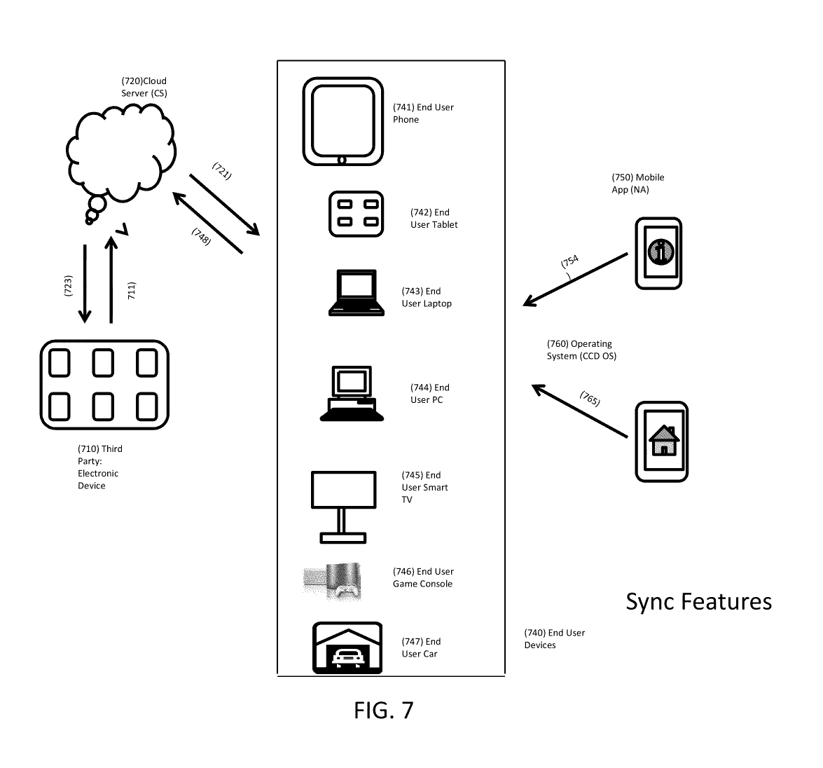

FIG. 5B is a flowchart diagram describing the steps of the users electronic device in locking and unlocking the device remotely via a gateway server in communication with a native application (NA) that is processing an Unlock Status Code. In step 544, the user electronic device(s) receives a request to lock at least one of the user device functions: the internet, cellular, and/or SMS; and on one or more user devices. This may occur with the NA reading the Unlock Status Code after being powered on, for example. It is also noted that all of the user devices comprising internet and/or cellular data may be simultaneously locked (e.g. see FIG. 7). In step 546, the device's designated functions will be locked based upon the Unlock Status Code. In step 548, the device's designated functions will be unlocked upon the occurrence of a condition, such as the successful completion of a task by the user (step 550), passage of time (e.g. on airplane or time of test duration) (step 552), and/or location of device detected with a specified GPS location (step 554).

### Alternative Implementations

In one implementation, all Educational Content (EC) and/or Learning Content (LC) is preloaded with the persistent data storage associated with the NA, such that it is not required to access CS to obtain such content.

In one implementation, all EC and/or LC is pre-cached in the persistent data storage, such that periodically, the NA pre-loads data that is ready on hand—for instant on-device access when needed. This circumvents problems that may occur when device internet connectivity is absent or problematic, and increases speed and performance of unlocking. This pre-loading may occur in two ways: 1—Periodically the NA will check for updates to pre-loaded EC and/or LC data as a TSR (terminate and stay resident) process. 2—At each use of the NA for unlocking, the NA will check to see if it needs to update its pre-loaded data, which it will then fetch and have pre-loaded for future uses of the NA.

In one implementation, one, many, or all of the CS are not controlled by URL access to an external server hosting the CS, but rather, are controlled by the wireless carrier (WC) itself. Any attempt to access the WC's mobile data plan, SMS or MMS texting services, or telephony services, will be regulated by the carrier's servers and infrastructure, which will emulate the CS as already described in internal server APIs. The WC's internal server APIs will provide responses and information to its other services letting those services know whether they are currently locked and require unlocking via interaction with educational content, or have a different status as already described above in the different status conditions that the USC may indicate.

In another embodiment, the CCD for establishing the unlocking criteria could be the same CCD used for “establishing the unlocking criteria”.

Detailed Description of Individual Items within FIG. 5:

The following definitions are an extension of the illustrations of FIG. 5, which one familiar with the art would recognize as industry terms that can be defined in multiple ways but similar meanings.

Cloud-Connected Client Device (CCD)—This is any consumer electronic device which has an operating system (OS) and internet access, inclusive of but not limited to: iPhone or other smartphone, iPod or other portable music player, iPad or other portable tablet device, laptop computer, desktop computer, netbook computer, XBox or other game console; Google TV or other television set-top box, or smart-TV with embedded computer hardware and OS; and so on.

Native Application (NA)—This is an application that natively runs on the CCD's OS, either pre-installed to run at the login stage of the OS's boot sequence, or post facto installed on the CCD to either run on top of, concurrent with, or in lieu of, processes that the OS executes at the login stage of the CCD's boot sequence that is called upon power-up or restart/reboot or logout/login new user. For devices with sleep mode, such as always-on smartphones, the NA will also run at the preliminary stage the OS typically calls for logging into or unlocking of the device from sleep.

Cloud Services (CS)—To the CCD, the CS represent a family of web services that may be hosted on one isolated server, multiple isolated servers, or on distributed servers that virtually and agnostically appear to the CCD to be a single server. Individual CS web services are accessible by URL which contains both the address of the server to contact, the name of the particular web service to access, and the parameters of payload data to deliver to the web service, in the typical fashion of URL construction. The resource return by accessing the URL shall be a data packet (DP) in a proprietary data interchange format, or a common data interchange format such as XML or JSON. The primary and most important CS web service for this disclosure, is the one where the NA first checks in with the CS, reporting such information as for example, GPS location, GPS location history, device usage history, and so on; and is returned the USC and optionally the EC (unlock status code and educational content). Other conditional logic may also be returned in this data packet, such as restrictive parameters for what time of day the device may be used, certain logical criteria for device usage (including but not limited to: 1—number of minutes that it may be used, 2—which applications may be used how often and/or when, 3—how much educational content must be interacted with correctly, 4—how much learning content (LC) must be viewed and for how long, 5—what conditional logic flow should be followed in case educational content is incorrectly responded to, and so on.). In some implementations, CS are isolated or divided onto isolated different servers to facilitate the isolation/organizing/management of diverse families of functions that may be accessed by some authorized parties but not others. For example, CS involving rewards may be on one server. CS involving submittal of new EC and dispersal of EC to CCD may be on separate servers. CS involving managing and controlling the locking/unlocking CCDs may be on separate servers. In order to properly function, these separate servers may need to privately share information with each other via messaging and API calls, via common interfacing and messaging techniques known to those skilled in the art.

Educational Content (EC)—An easily understood example of educational content, would be true/false or multiple choice questions. (a) In many implementations, this is structured in a typical data format such as XML. (b) In other implementations, this is structured in a proprietary data format. (c) Besides the above, however, many other kinds of educational content are realizable. Since educational experiences are certainly not always in the form of viewing questions and giving answers, a very good example of an alternative form of educational content, would be content constructed with HTML-5+CSS+JavaScript—a web application. In this example, any possible way a web application can perform, present to, and interact with a user, becomes the educational content/educational experience that is presented to the user. In such implementations, whatever kind of interaction is deemed correct (be it amount of time, proper hand-eye coordination, proper navigation to a GPS location, proper answering of a question, proper composition of an essay, and so on) would be made known to the NA such that it can logically determine whether to unlock the device or do otherwise.

Unlock Status Code (USC)—This is a code within the DP (data packet) that instructs the device with current unlock instructions. For example, the USC could instruct the device that under no circumstance should it unlock (except to use emergency services). Or the USC could instruct the device that, because it is a holiday or weekend or vacation (or other condition), that it should immediately unlock without any requirement for educational content. Or the USC could instruct the device that it must present the user educational content with which to interact, for a certain length of time, certain number of questions, certain percentage of correct responses or interactions, and so on.

Learning Content (LC)—Learning content (LC) is herein defined differently from EC, in that it is content which does not necessarily require interaction. It can be media such as video, audio, text, other media, or combinations of the foregoing. It may be presented to the CCD user prior to them interacting with EC, so that they have learned and are prepared to correctly interact. Or, it could be also presented after an incorrect interaction with EC, in order that the user may learn the correct interaction therewith.

### Locking Software Component

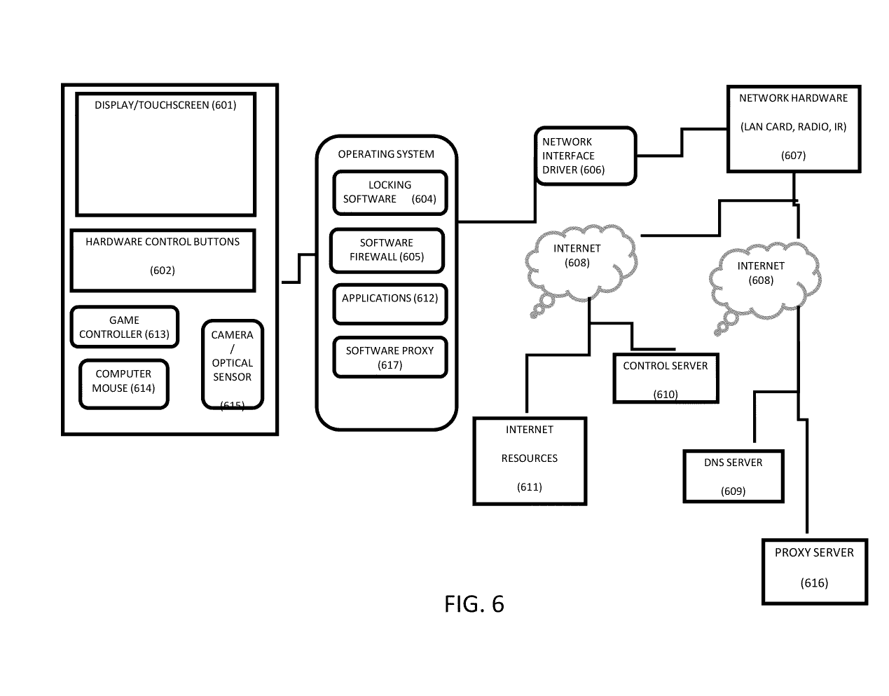

FIG. 6 is an illustration of the Locking Software combinations that can serve to effectively disable features of a device utilizing the iOS operating system (such as smart phone, lap top, notebook, notepad, smart tv, smart cars, etc.) until the user completes one or more desired tasks that will allow the user to earn back time or features. In particular, the following are an overview of each of the individual numbered features.
Whereas the device has a user interface 600 comprised of a display to view operating system 603 output and application 612 output as well as one or more methods to detect user input, including but not limited to hardware control buttons 602 such as a keyboard or function key, a touch screen 601, a mouse pointer device 614, a camera or optical sensor 615, and/or a game controller device 613.
Whereas the device has a software or firmware based operating system 603 that allows applications created by third parties to accept input from the user interface and to control output to the display 601.
Whereas the operating system 603 exposes one or more application programming interface(s) to allow third party applications 612 to monitor and/or intercept device user interface 600 input, and to control the device hardware through software commands.
Whereas the operating system 603 exposes one or more application programming interface(s) to allow third party applications 612 to selectively kill running processes or applications 612.
Whereas the operating system 603 has a method of utilizing network connectivity hardware 607 such as a network interface driver 606 to allow the device to connect to a plurality of computer devices on a network, such as the Internet 608.
Whereas the device operating system 603 or third party application 612 provides a software firewall 605 that is capable of controlling access to the network by selectively allowing or denying access to the network.
Whereas applications 612 often require access to the internet 608 and more specifically to internet resources 611 such as a control server 610 that may include application functionality support and a database containing data essential to the functionality of the application 612.
Whereas the operating system 603 requires connectivity to a remote DNS (Doman Name Service) Server 609 in order to support application 612 access to control servers 610 and internet resources 611.
Whereas the operating system 603 maintains network connectivity settings, including an internet protocol address for the device's network hardware 607 as well as remote service addresses including the IP address of one or more DNS (Domain Name Service) servers, as required to provide name resolution for accessing a control server 610 and other internet resources 611 such as a website or web service.
Whereas the operating system 603 supports applications 612 such as Locking Software 604 starting each time the operating system 603 is initialized.

Using FIG. 6 and the definitional references provided as a background, the Locking software 604 could provide one or more layered lock methods to ensure that users utilize the device in a particular way.

The lock methods referred to herein as part of this disclosure include but are not limited to:
1. Instruct the Locking Software 604 to present display 601 output that occupies the entire display, and intercepts all user interface 600 inputs to selectively disregard any input that would cause the Locking Software 604 to stop or close.
2. Instruct the Locking Software 604 to modify the Software Firewall 605 rules such that access to the Internet 608 is selectively disabled.
3. Instruct the Locking Software 604 to command the operating system 603 to use a software proxy 617 to inject Locking Software content in the response data from internet resources 611.
4. Instruct the Locking Software 604 to command the operating system 603 to disable the network hardware 607 so that connection to the network or internet is disabled. (Airplane Mode)
5. Instruct the Locking Software 604 to command the operating system 603 to use a DNS server 609 that is interfaced or associated with the Locking Software control server, effectively redirecting all remote internet resource 611 requests back to the control server 610 for selective processing.
6. Instruct the Locking Software 604 to command the operating system 603 to use a proxy server 616 that is interfaced or associated with the Locking Software control server, effectively filtering all remote internet resource 611 responses for content replacement or injection.
7. Instruct the Locking Software 604 to command the operating system 603 to kill any running process that is not explicitly allowed by the Locking Software or required by the operating system.
8. Instruct the Locking Software 604 to command the operating system to disable network hardware 607.

### Multiple Device Synchronization

FIG. 7 describes one possible example of how the synchronizing of multiple devices including, inter alia, IOS based devices, could be achieved in order to block a targeted end user from changing devices to gain access to the desired application such as social messaging, gaming, etc. Synchronization is a relevant consideration to the current disclosure because it is common for children to have access to multiple devices such as their own smart phone, a shared laptop, a shared smart TV, etc.

FIG. 7 illustrates a system using a specific example of answering multiple questions from multiple devices 740 which includes but is not limited to the devices listed from 741-747. In particular, the parent uses their third party device 710 to make a request to-through the cloud server 720 for their child to answer 5 math questions through any individual or combination of electronic devices thru 711. The cloud server then sends requests to the child's electronic device 740 thru 721. Once the request is fulfilled and processed from the child's electronic device 740 the information is sent back to the cloud server 720 thru 748. The cloud server 720 will then send the answer back to the third party device 710 to confirm the request has been fulfilled, in this case identified as the parent, thru 723. The NA 750 will include a component that will synchronize all of the selected electronic devices to the cloud server 720 in such a way that each device functions as if it were the same as it relates to answering the command it was given from the cloud server 720.

In another embodiment, the synchronization of locking multiple devices can be used alone to remotely lock a group of smart devices without having a direct link to education content or a reward system. The synchronization of locking multiple software mechanisms is an important feature to creating a block on the targeted electronic devices (i.e. smart devices) that cannot be easily circumvented by the targeted end user (or groups of end users) of the smart devices and can be controlled remotely by a third party. For example, in one instance a parent may want to lock his child's access to each of the electronic devices in the child's home while the parent is not also at the home whereas in another instance an employer may want to lock his employees access to a certain number of his electronic devices but not all (such as locking out of all electronic devices except a tablet). This aspect of the disclosure is not limited to these examples as these are intended to act only as a reference as a component of the disclosure.

In yet another example, the synchronization of the locking of multiple devices could include a sequenced approach such that each level of questions only provides access to different smart devices. For example, completion of SAT questions provide access to smart phone, while questions to GMAT provide access to a tablet, while instructions to run a specific distance over a specific time provide access to game console, etc. This example indicates that any combination of sequencing is an embodiment of the disclosure. In yet another example, the locking mechanism could be triggered by using retail based coordinates such as those used by Groupon or Facebook Nearby such that any combination of GPS restrictions are placed on a child by a parent. For example, if a child elected to go to a loud restaurant rather than a quiet coffee shop the parent could alter the accessibility of the electronic device from a complete block to partial based on varying types of questions or instructions.

### Retail Reward for End User

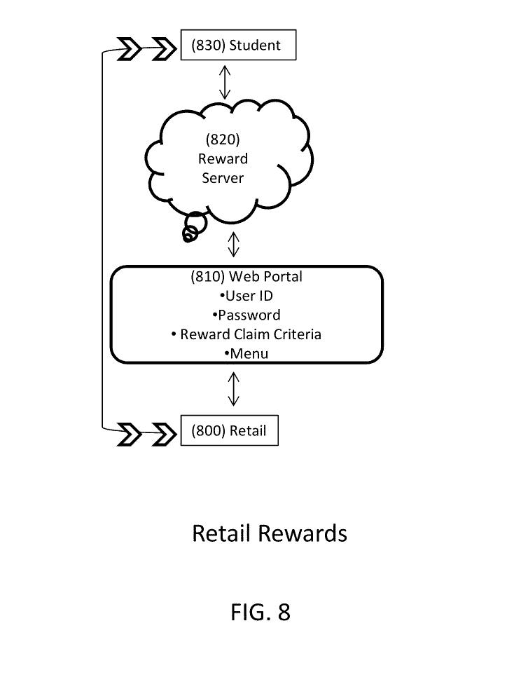

FIG. 8 describes one embodiment of the disclosure and the rewards system 820. In one example, Starbucks the retail vendor 800 goes to the web portal 810, which is part of the reward server 820, and identifies themselves through traditional login security, and enters rewards promotional information, rewards claim criteria (which may include but is not limited to GPA, passing percentage, test scores, local trivia questions, and so on), and any other information relevant to the promotion, the redemption requirements, and so on. The web portal 810 through the rewards server 820 processes this information and links it to the student 830.

In one implementation, once linked to the student's device 830 a message is activated at a given time or when the student enters a Starbucks retail store 800 as determined by location-based services on the smartphone such global positioning system (GPS). Those familiar with the arts would recognize that GPS services are well practiced by companies such as Foursquare and Facebook Nearby.

Alternatively, the student enters a Starbucks store and wants to see if they have a reward at that Starbucks 800 the student 830 can choose to view their rewards from an in-app menu and select the Starbucks 800 reward. In some cases the retail store 800 could be the retail vendor who inputs the reward system parameters; and, in another case a corporate office of Starbucks could provide the parameters, thru the web portal 810.

If the student 830 chooses a particular reward to redeem, the device application will connect to the rewards server 820 which will optionally provide an electronic coupon code to the student 830 through a mechanism such as a bar code, numeric code, or code communicated to point of sale through NFC communication. Once the student 830 redeems the reward, the coupon redeemed may be matched against the coupon issued thereby ensuring that the coupon can only be used once. In another example, when the rewards clouds receives the indication that the student has achieved a reward, the rewards server 820 can instantaneously give credit to the students 830 Starbucks Gold Card, allowing the student to make a purchase directly.

In some implementations of the various embodiments, rewards offered and/or given to the user of the device have alternative manifestations. In one implementation, a native or web application presents an option to the user for location-based check-in, which allows the user to indicate via user interface such as a button or slider that s/he is checking in at his/her current location. The native application may use the device's native location services which use GPS and other means such as APIs which report location based on Wi-Fi SSIDs and/or triangulation based on signal strength of cell towers; or the native application or web application may use various means such as web services where location is sourced via IP address. This information is transferred via internet to web service API(s) at server(s) which record this information in database table(s) associated with the user and his/her device. Based on device access rules that have been specified by Third Party on same server(s), application logic is triggered on the server that, based on compliance with check-in rules, will trigger the offering or awarding of rewards to the device user.

For example, Third Party might require a device user on certain days of the week to (1) show up and check in to a school location by a certain time, (2) check in as still at school at the end of the school day, (3) check in at home by a certain time, (4) check in at home later in the evening to prove the user is still there. Rewards rules can be specified such as all four rules must be met for five days in a row to trigger a full allowance, or that for each check-in, $2 is accumulated into the allowance credits, or indeed, any number of other rules for rewards as described elsewhere. Each “check in session” could include specific unique learning questions or instructions that are customized to the end user to further confirm that the end user and the end user's device are in the specified coordinates requested by the third party.

While this embodiment does not include the locking mechanism created by a third-party, one familiar with the art could incorporate that into this example. Further, in another embodiment a random reward could be generated for those who participate in the reward contest. In a random reward any participant including the winner of a contest could be rewarded.

### Multiple Content Provider System for Retail Reward Contest

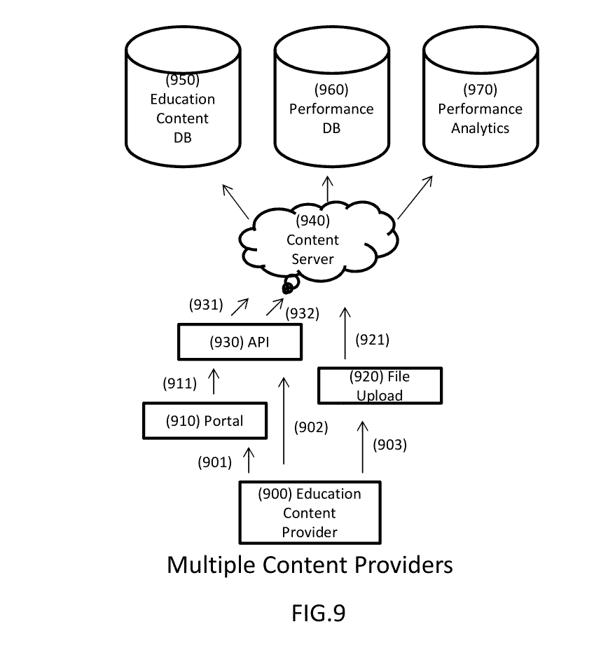

FIG. 9 describes the potential avenues for education content providers 900 to upload content into the content server 940. In the first example, the education content provider 900 can use the portal 910 to transfer content thru 901. The portal 910 has two ways for the content provider 900 to transfer content thru the portal 910. There is the data entry option which allows the content provider 900 to manually enter questions, answers, media links, audio videos, ebooks, etextbooks, etc. and the like in the portal 910 and upload it onto the content server 940 using API 930 thru 911 and 931. Alternatively, the content provider 900 can use common methodologies for specifying HTML-5/web app content.

In another example, the education content provider 900 thru API 930 can transfer content directly to the content server 940 thru 902 and 932. Additionally, the education content provider 900 can use a file upload using formatted content (such as files like CSV. or XML) 920 to transfer content into the content server 940 thru 903 and 921. In all cases the information received by the content server 940 will interact with the education content base 950, performance database 960, and performance analytics base 970 to ensure that the content input by the content provided gets directed to the end users. While this embodiment does not include the locking mechanism created by a third-party, one familiar with the art could incorporate that into this example.

### Randomly Generated Password or Passcode

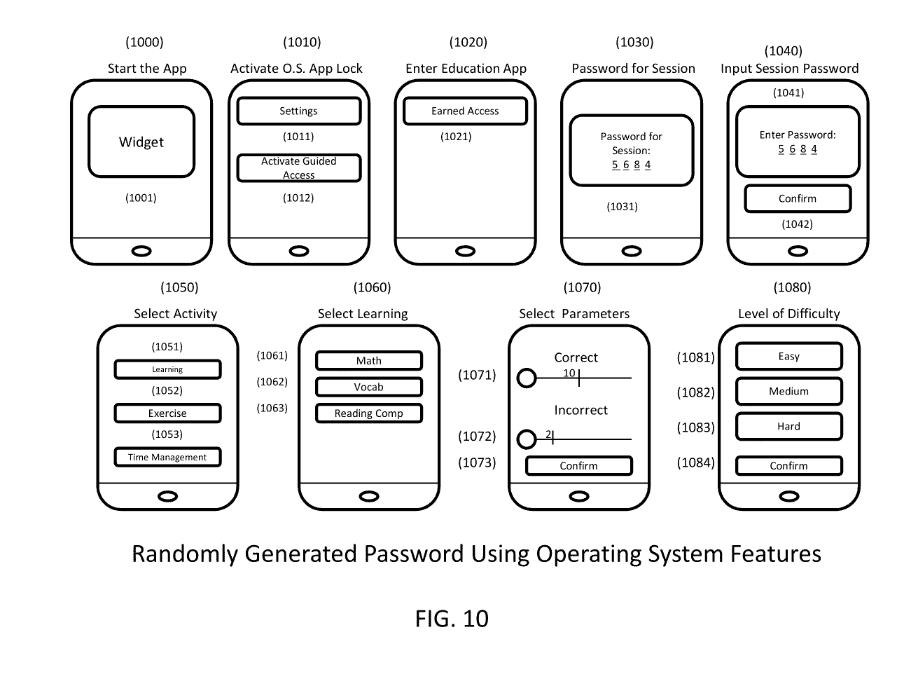

In one embodiment, a randomly generated password or passcode feature enables the smart device to generate a random passcode for the administrator and the only way to unlock the device is by completing a user or third party selected task, such as targeted learning, exercise, or time management objectives. While the examples provided in FIGS. 10-12 reveal a Randomly Generated Password or Passcode, the same examples could be used for describing a sequence where the target device is locked and then unlocked based on a condition (such as unit of time or earning) and the earning is done intermittently (between locking and unlocking) as described elsewhere, such as in FIG. 5.

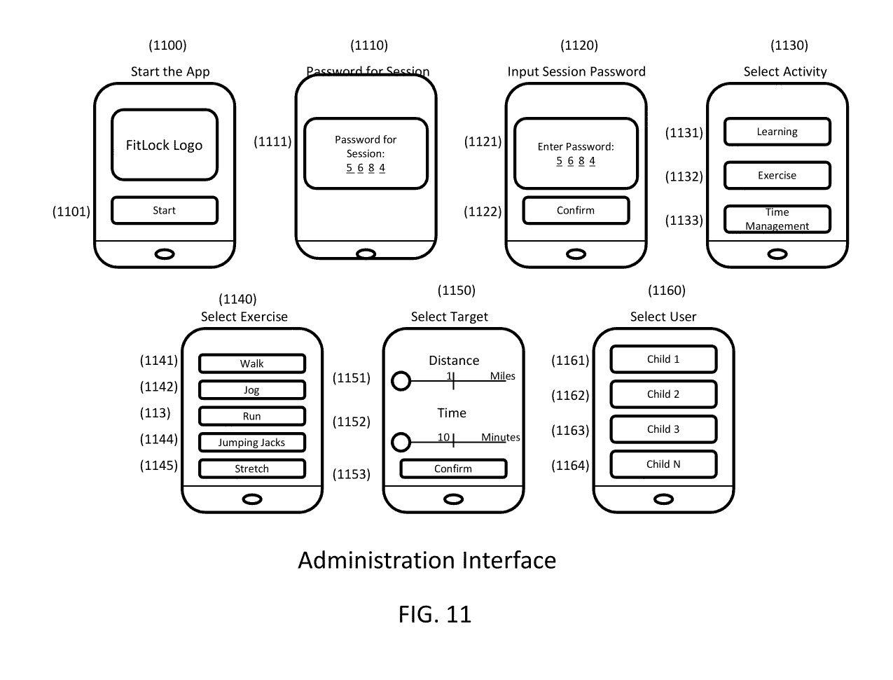

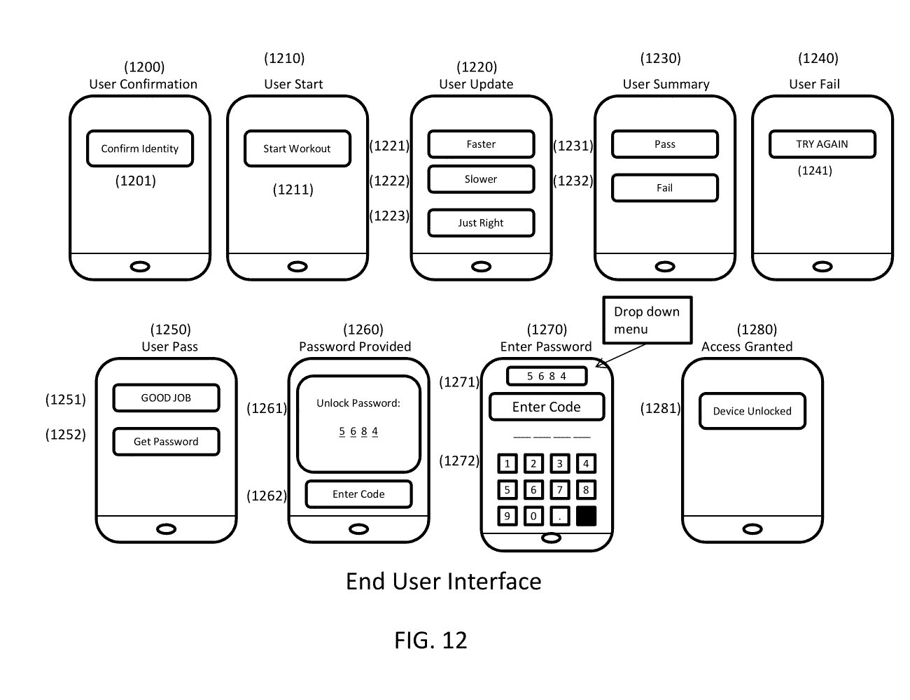

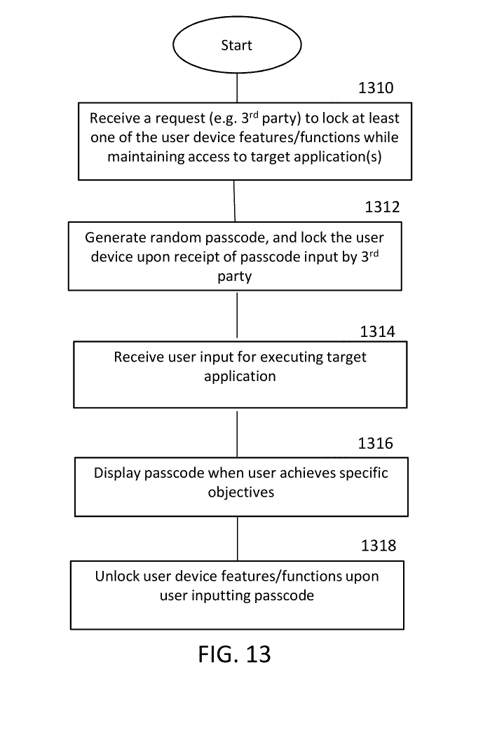

One configuration of the current disclosure has two components. The first is the administration interface which is illustrated in FIG. 10 and FIG. 11 and the second is the end user interface FIG. 12. FIG. 13 is a flowchart of the general computer steps on the user electronic device performed by the device processor in response to both 3^{rd} party and user input.

In one embodiment of the current disclosure, the administrator will have the ability to register himself and the device by email, passcode and related demographic information such as age, sex, zip code, height, weight, etc. In addition, the administrator will have the ability to register the individual end users as well for similar information. In one example, a parent would register the device to their personal email, set an administrative passcode (that protects the administrative data inputting for the current disclosure), and then have the ability to register one or multiple children to the device under the control of the administrative passcode. The mechanism by which the administrator registers his information including information about the device and end user or end users would be well-known by those familiar with the art.

FIG. 10 Randomly Generated Passcode Using Operating System Features: FIG. 10 describes one embodiment of the current disclosure and the operating systems app locking mechanisms interacting with the random generation of a passcode. For example, Apple's Guided Access feature and the Kindle's “Kindle Free Time” are two operating systems that enable the user or administrator of a user to “lock” in a particular application on the electronic device. In one example, the Guided Access feature locks the user into a specific application on a device whereby the user can only exit the “lock” feature by inputting a passcode. (A passcode that is the same passcode that the user or administrator of the user selected into order to engage Guided Access). In another example, the “Kindle Free Time” feature instructs the device to limit the amount of time a user can spend on the device. Again, this feature of “Kindle Free Time” is passcode protected.

The current disclosure describes a situation whereby a randomly generated passcode from a targeted application is supplemented with education driven questions or other selected activities (e.g. physical exercises) and then interacts with the operating systems locking and/or time limiting features. Thus, it is the targeted application that instructs the device's administrator and user on a session specific passcode to both “lock” or “unlock” the electronic device.

In one implementation of the disclosure, the user of a smart device will start the application 1000 by identifying the widget and clicking the widget 1001 to start the application. The application started is the learning (or instructional app) and it includes the random passcode generator for both the “lock” and “unlock” mechanisms.

Continuing with this example, the user of the smart device will then be directed to the settings page 1011 and then be prompted to activate the locking feature 1012 that is already embedded into the operating system of the electronic device (such as Guided Access) and such action can be optionally confirmed 1013. In another example, the user could be directed to the settings page of a time limit feature like “Kindle Free Time”.

After the user initiates the Guided Access (or equivalent) feature 1012 he/she will then be prompted to enter the desired application he/she wishes Guided Access to interact with. Alternatively, the user could enter the targeted application such as the case with 1000. In this example, an application that is education based 1020 is selected from the starting of the app. Once the user activates the desired target application, a randomly generated passcode 1030 will appear. The passcode is randomly generated but fixed to the number of fields requested by the operating system (such as 4 digits for Guided Access). The random number generation would be derived from any number of options one familiar with random number generation would create. In this example, the randomly generated passcode is “5684” 1031 and it is provided from the targeted app. After the randomly generated passcode is presented to the user, the user would be directed to the input session passcode page 1040 which is a component of Guided Access feature. Next, the user is instructed to input the previously presented randomly generated passcode 1041 and then confirm the action 1042 into the Guided Access feature. At this time, the educational (or instructional) target app was responsible for generating the passcode to “lock” itself in using the locking system offered by the operating system. (In this example, the feature referred to as Guided Access but could be any type of locking system that requires a personal passcode.)

Further continuing with this example, after inputting and confirming the randomly generated passcode, the user would then be directed to the select activity page 1050. In one example, the user has the option to select from a list of features within the learning (or instructional) application. In this example, those features are learning 1051, exercise 1052, and time management 1053. In one example, the exercise feature 1052 could be a set of instructions that require the user to complete a series of exercise objectives in order to gain access to the smart device. In another example, the time management feature 1053 could be a set of instructions that require the user to complete a set of tasks or “chores” prior to gaining access to the smart device. Further continuing with this example, the time management feature could track and store the user's usage of the device by application. In this example, the user selects the learning feature 1051.

After the user selects the learning feature 1051, the user will be directed to the select learning page 1060. On this page, the user will be presented with a menu of options to choose from. The menu will present information such as the following, math 1061, vocabulary 1062, and reading comprehension 1063. In one example, the types of questions presented to the user could be in the form of multiple choice, true/false, sequencing, multiple selection, fill in the blank, and the like. In this example, the user selects the math icon 1061.

Continuing with this example, after selecting the math icon, the user would then be prompted to the select parameters page 1070. The select parameters feature allows the user to input a set of parameter that will ultimately instruct the device to either stay locked or unlock at the end of the session. In this example, the user selects the desired correct answers to be “10” 1071. Next, the user could then input the total number of incorrect answers allowed during the particular session. In this example, the user selects that number to be “2” 1072. In both of these examples, the objective of this feature is to allow the user to choose the parameters required to unlock the device. For example, the user could be a third party parent who wants their child to improve their math skills After inputting the parameters, the user (e.g. third party) would click the confirm icon 1073.

Further continuing with this example, after selecting the parameters, the user would then be directed to the level of difficulty page 1080. On this page, the user has the option to select the level of difficulty. In this example, the levels of difficulty to choose from are easy 1081, medium 1082, and/or hard 1083. After the user selects the level of difficulty s/he would then confirm the selects 1084. After the confirming the targeted learning (or instructional) application has been defined, the electronic device can only be “unlocked” with the randomly generated passcode which was created. However, the same randomly generated passcode will be provided once the targeted learning levels have been achieved. By using this approach the administrator is relieved of the burden of having to create a session specific passcode. The administrator is also relieved of the burden of having to share the passcode with the user-child (when user has completed the exercises or instructions); and, the user is motivated to earn the targeted learning levels so he can be provided the passcode that will “unlock” the device and provide him access to other features of the device.

### Administration Interface 11 (e.g. 3^{rd} Party)

The administration interface and experience in this configuration has seven steps for the administrator to complete in another configuration.

The first step is the administrator opens the target application and is directed to the start page 1100. The administrator will then start the application by selecting the start icon 1101.

In the second step, the administrator is directed to the passcode generator page 1110, where the application automatically creates a randomly generated passcode specific for the particular session 1111. In addition, the randomly generated passcode will be sent to the administrator's email for a reference. Sending the randomly generated passcode to the administrator's email provides a backup reference to the administrator so the passcode is not forgotten. The passcode could be sent via another electronic means such as text or voicemail for example. In the case of this example, the randomly generated passcode is “5684”. The means of random generation is well-known to those in the art and it not limited to four digits or numbers. In some cases the random generation includes letters, combinations, as well as patterns.

In the third step, the administrator is directed to the input the session passcode 1120. In one example, the administrator will enter the passcode 1121, which for this example is “5684”, and confirm the passcode by selecting the confirm icon 1122 and reentering “5684” (for this example). The confirmation step will cross reference the entered passcode to ensure the passcode was entered correctly.

In the fourth step, the administrator is directed to the select activity 1130 page where information, such as the following, is displayed: learning 1131, exercise 1132, and time management 1133. In one example, the learning icon 1131 will allow the administrator to select education content and questions for the end user to complete. In one example, the exercise icon 1132 will allow the administrator to select specific exercise objectives for the end user to complete. In one example, the time management icon 1133 will allow the administrator to select objectives to be completed by time by the end user such as daily chores and homework. In this situation, the administrator selects the exercise icon 1133.

In the fifth step, the administrator is directed to the select exercise 1140 page. This page will display information such as the following: walk 1141, jog 1142, run 1143, jumping jacks 1144, and stretching 1145. In one example, the walk 1141 feature will allow the administrator to select distance and time objectives for the end user to complete at a walking pace. In one example, the jogging feature 1142 will allow the administrator to select distance and time objectives for the end user to complete at a jogging pace. In one example, the running feature 1143 will allow the administrator to select distance and time objectives for the end user to complete at a running pace. In one example, the jumping jacks feature 1144 will allow the administrator to set a number of jumping jacks to be completed by the end user using an accelerometer. In one example, the stretch feature 1145 will allow the administrator to select specific stretching techniques. In this situation, the administrator has selected the run icon 1143.

In the sixth step, the administrator is directed to the select target 1150 page. In this example, the administrator can select the distance 1151 and time 1152 objectives. In one embodiment, the distance 1151 will have a toggle feature whereby the administrator can select a distance between, but is not limited to, 0 miles to 10 miles. The distance can be measured by any means from which the difference between two points (start and finish) are calculated. In one embodiment, the time 1152 will have a toggle feature whereby the administrator can select a time between, but is not limited to, 0 minutes to 60 minutes. The time can be measured by any means from which the difference between two times (start and finish) is calculated. In this situation the administrator selects one mile to be run in 10 minutes or less. After entering in the target objective requirements, the administrator selects the confirm icon 1153 to ensure that administrator's desired target objectives for the end user are correct.

In the seventh step, the administrator is directed to the select user page 1160 and the administrator selects an end user 1161. In one example, the end user can be one of the children of the administrator, or multiple children 1161-1164.

After selecting the targeted end user, the administrator will provide the device to the chosen end user.

### End User Interface

The end user experience, in this configuration, has nine steps: user confirmation 1200, user start 1210, user update 1220, user summary 1230, user fail 1240, user pass 1250, passcode provided 1260, enter passcode 1270, and access granted 1280.

In the first step, the target end user gets the device from the administrator, the end user will confirm his/her identity by selecting the confirm identity icon 1201. In one example, the administrator can have multiple children registered to the device and the user confirmation 1200 feature is to ensure the end user is the precise one the administrator selected.

In the second step, after the end user confirms his/her identity, the end user will be directed to the user start 1210 page. The end user will select the start workout icon 1211 to begin the workout. In this case, the user starts the workout by pressing the user start 1211 and then commences his run.

In the third step, the end user is directed to the user update 1220 page where the end user is provided information such as the following: faster 1221, slower 1222, and just right 1223. In one example, this information will be directed to the user to notify the user if they are behind pace, ahead of the pace, or on pace to complete the targeted objective. For example, symbols, words and colors can be used to inform the end user of his progress relative to the target objective. In this situation, the administrator selected one mile to be run in 10 minutes. This translates to a 6 mile an hour average. The miles per hour can be tracked by GPS system using techniques that are readily available such as Nike+. If the end user is running slower than the target objective the word “faster” could appear. Whereas if he were running faster than the target objective the word “slower” could appear. Also, in the case of running 6 miles per hour the word “keep it up” could appear. In another example, the user update will be linked to music or vibration patterns on the device to keep the user on pace. In this example, the end user could select specific songs that will alert him as to his status relative to the goals. Thus, the end user might pick a relaxing song when he is faster (relative to targeted goal) and an upbeat song when he is slower (relative to targeted goal).

In the fourth step, the end user will be directed to the user summary 1230 page. Here the end user will be notified if they have passed 1231 or failed 1232. In addition, a summary of results such as 1.0 miles in 9.00 minutes or 1.0 miles in 11.25 minutes or 0.9 miles in 10.00 minutes. Any combination of summary results can be collected to be used to assess the achievement of the stated goal as well as the collection of historical information for analytical and tracking purposes.

In the fifth step, the user does not pass the workout and is directed to the user fail 1240 page. In this situation, the end user was unable to complete the 1.0 mile run in the 10 minute target. In order to unlock the device, the user has to select the try again icon 1241 whereby they will be directed back to the user start 1210 page and will have to begin the work out all over again. (In this situation, the try again option does not require any input from the administrator; however, in some instances the administrator may wish to have the ability to adjust the target objectives as a means of further encouragement for the end user.) In all cases, the administrator will receive an email at the user summary level notifying the administrator the status of the workout, either pass or fail. In one example, if the user fails three consecutive times, the administrator will receive three separate emails and may have the ability to remotely change the target objective or modify the access of the device based earnest efforts of the end user.

In the sixth step (which would actually be the fifth step if the end user passes on his first attempt), the end user passes 1251 the workout and will click the get passcode icon 1252. In one embodiment, the user will see a congratulatory alert notifying the user that they have passed the workout 1251.

In the seventh step, after selecting the get passcode icon 1252, the end user will be directed to the passcode provided page 1260 where the device will provide the randomly generated passcode that was entered by the administrator. In one example, the application may request that the end user write down the passcode code or the application may have a drop down feature 1271 which provides the same. In one example, the passcode, 5684, is displayed to the end user in the unlock passcode 1261 alert. Next, the user will click the enter code icon 1262.

In the eighth step, after clicking the enter code icon 1262, the user is directed to the enter passcode page 1270. The user will then enter in the randomly generated passcode, 5684, using the keyboard 1272. If the user forgets the passcode, the drop down menu 1271 will provide the code again and the user can enter the code using the keyboard. In another example, the randomly generated passcode could automatically be inputted into the data field.

In the ninth step, the end user is directed to the access granted page 1280. Next, the end user selects the device unlocked icon 1281 and is then directed to the normal devices landing page and full functionality via the home button or other means common to the operating systems of the target device.

In all cases an emergency override mechanism will be made available to both the administrator and the end user.

FIG. 13 is a summation of computer steps performed by the user electronic device for both the administrator and user functions disclosed in FIGS. 10-12. In step 1310, the user electronic device's processor receives a request, such as from a 3rd party parent, to lock at least one of the user device features/functions while maintaining access to target application(s) (e.g. “select activity”, FIG. 11, 1130, “Learning”, “Exercise”, “Time Management”). In step 1312, the user electronic device generates a random passcode or password, and locks the user device upon receipt of passcode input by the 3rd party. In step 1314, the user electronic device receives user input for executing a target application (e.g. FIG. 10, 1060-80; FIG. 12, 1220). In step 1316, the user electronic device displays on the graphical user interface the passcode generated in step 1312 only when the user has achieved a preprogrammed objective, such as FIG. 12, 1250. And in step 1318, the user electronic device unlocks the locked designated features in response to the user inputting the passcode.

### Further Examples of Optional Features with Current Disclosure

### Sound Level Control

A voice decibel mechanism that will shut down the system (or otherwise modify) if the electronic device detects a sound emitted from the user (or from the device itself) at a level higher than a pre-set limit. One familiar with voice decibel systems and the widely available applications to record and detect the decibel level from the electronic device would understand the manner in which the hardware of the electronic device already contains the detection and measurement equipment. In particular, the United States Patent Application 20130039501 A1 • file Aug. 7, 2012 entitled, System, Method, and Computer Program Product for Voice Decibel Monitoring on Electronic Computing Devices application describes many of the features capable of being monitored by the electronic device. This feature of the present disclosure will be particularly useful in a classroom setting where one student might be enjoying a privilege he earned by playing a game while another student is still earning time. However, any other environmental settings where the sound level is concerned are relevant as well.

Optionally, the sound level control could simply remove some or all of the time that was earned. Further, the sound level control could send out a warning before taking an action of shutting down or removing time. In the case of the volume of the device exceeding the established limits the device could adjust itself to the appropriate level or simply eliminate its sound emitting capability for a specific time, or event such as use of a particular application or function.

### Lottery

Further still in another embodiment, the learning reward system can include a progressive lottery type of syndicate whereby it is a linked system. In this system a group of students join into a particular type of learning or sign up for a particular type of reward that is provided by a corporate or retail sponsor. For example a group of students studying similar content for a test prep such as the SAT could all compete for a random reward. Specifically, the commonalty is the SAT content and they are each competing for a randomly generated reward. Conversely, a group of employees within a large organization with multiple locations around the world could sign up for a specific reward (such as additional vacation time, a gift certificate for coffee, etc.) regardless of their job training content. Specifically, the commonalty is not the learning content—it is the specific reward.

In another case, the students could wager their accumulated time against each other whereby a single winner or group of winners takes all or the majority of the collective time. The competition amongst the students could include games one familiar with motivational behavior would know and include those games based on a skill or knowledge, a physical action (like running), a physical change (like gaining or losing weight), luck (like those associated with compulsion) or game of chance or any combination.

### Global Positioning Satellite (GPS) Systems

In the case of tracing GPS coordinates, many smart devices come with a built-in GPS function. The GPS function is a byproduct of using a smart device. For example, the built-in receiver trilaterates your position using data from at least three GPS satellites and the receiver. GPS can determine ones location by performing a calculation based on the intersection point of overlapping spheres determined by the satellites and your phone's GPS receiver. In simple terms, trilateration uses the distance between the satellites and the receiver to create overlapping “spheres” that intersect in a circle. The intersection is your location on the ground. This GPS feature has been incorporated into a number of native applications and web based applications that incorporate the smart devices user's location. Examples, include Groupon, Facebook Nearby, Event Seeker. In each of the examples, the smart device user can be informed when he enters a specific set of coordinates about a particular discount at restaurant, a friend's proximity or a an entertainment event. The “GPS coordinates” demonstrates what one familiar with the art could do to enable the smart device to become a tracking beacon for periods of time that include until a target event occurs or the passage of a prescribed amount of time.

Using GPS signals, the students are identified while in a Retail store and join the contest through their electronic devices. In one embodiment each of the students is in the same location in another embodiment the students are in different locations. In another example, students can represent groups of students in classrooms or any group, such as a church group. In lieu of the GPS coordinates, the activity of the contest could include any type of membership program that could allow students or groups, to enroll and compete in the contest from remote locations, through the cloud.

The assessment and gateway functions may further comprise utilizing location based content and calculating the location of the user via, for example, the use of global positioning system (GPS) capabilities on the user's electronic computing device. The user may be required to perform a physical task (e.g. running around neighborhood, walking home from school at certain time and route) that is tracked by the user's device. Likewise, the content of the questions is location based. For example, a student walks into a math class 5 minutes before class starts and he would like to text. The gateway would be math themed questions of the day sponsored by the teacher of math questions customized to the student's current trends on tests and quizzes. And in a commercial setting, a customer at Starbucks® might be asked a series of questions about the nutritional value of his most recent purchases. Further still, in a employment setting the employee may be asked a series of questions about laboratory safety or emergency exits as they move from one plant to another.

### GPS-Based Trigger for Locking and Unlocking Mechanism

In yet another aspect of the disclosure, the reward is initiated by the global positioning service (GPS) of the electronic device and the relative location of the student using the electronic device. For example, in one case the student could be walking home from school and passing by a Starbucks. At such time, as he falls with a specific boundary of the GPS coordinates relative to the Starbucks a reward potential could be activated to induce the student to learn in exchange for an immediate reward upon completing a particular learning assignment, at which time his device would be unlocked so that he could complete the test, while other designated functions of the device remain locked (e.g. games, SMS, etc). As a simple example, the student could complete a module on his SAT prep at the Starbucks and receive an immediate reward.

In another case, a random reward could be location based where for example if a student was walking by a retail sponsor they could be informed of a particular reward. In the location based award a set of GPS coordinates would be activated such that any electronic device traveling within such GPS coordinates triggers a reward such as drop into Walmart for a discount or a free soda.

### GPS-Based Check-Ins for Locking and Unlocking Mechanism

In another example, a third-party might require the device user on certain days of the week to (1) show up and check in to a specific location such as a school location by a certain time, (2) check in as still at school at the same location end of the school day, (3) check in at home by a certain time, (4) check in at home later in the evening to prove the user is still there. Rewards rules can be specified such as all four rules must be met for five days in a row to trigger a full allowance, or that for each check-in, $2 is accumulated into the allowance credits, or indeed, any number of other rules for rewards as described elsewhere. Each “check in session” could include unlocking the device to allow the end user to answer specific unique learning questions or instructions that are customized to the end user to further confirm that the end user and the end user's device are in the specified coordinates requested by the third party.

### Electronic Device Usage/Credit Provided by Network Provider or Sponsor

In one scenario the student is provided a credit or full payment for their monthly service bill from their cell phone and/or cable carrier. The services that would be included would include all communications such as radio communications and satellite communications along with 2G to 4G Wi-Fi, cable and combinations as well. In a further example, the student is provided an electronic device and each day he earns time to access the features on the device in exchange for achieving targeted learning objectives. In a specific example, an at-risk child could be provided an electronic device and each incremental period such as a 24 hour period, a specific amount of learning content such as that related to the GED (general education diploma) would require a level of mastery in exchange for using the device for the incremental period. Further still, the results could be reported to third-party such as a sponsor or teacher or both.

### Anti-Cheating Mechanism

In yet another embodiment the disclosure may include a range of anti-cheating mechanisms. In one instance, the phone could be programmed with a motion detection sensor such that the user has to keep both hands on the phone. In one case he would have his left hand under the phone and his right hand held against the home screen while he calculates the answer in his head. In other words, an intent of the anti-cheating is to prevent the user from going to another device, such as a calculator or a friends smart device to solicit the answer. If a unauthorized motion is detected then a new instruction or question could be generated. In another instance of anti-cheating mechanisms an optical tracking software such as the programs created by Tobiis or the eye tracking software from Samsung in their Android 4.2 version. Using optical tracking if the user takes his eye off or away from the screen for a preset time such as 3 seconds then another instruction or question would be created for example.

In each case of an expected act of cheating, the result could be an immediate suspension of use, limited accessibility, reduced time, time subtracted, etc.

### Compulsion Loop

Researchers and scientists are frequently publishing reports that refer to the new levels of addiction to electronic entertainment. For example, one study of more than 1,000 students from 10 countries and 12 universities concluded that the majority were not able to voluntarily forego their electronic connections for a mere 24 hours. In particular, the study found that these college students admitted to being “addicted” to modern technology such as mobile phones, laptops and television as well as social networking such as Facebook® and Twitter®.

Functional magnetic resonance imaging (fMRI) was used, in another study, to visualize which parts of the brain were engaged during certain aspects of social media. The overall conclusions were that the use of social media, and in particular expressing one's owns opinion, positively triggers dopamine reward pathways. The researchers even determined that many of the subjects would prefer reporting their own experiences to receiving a monetary reward.

Similar indications were noted in certain video gaming, which introduce high levels of “randomness” in reward granting as an intentional means of forming an addiction. The idea dates back decades and its used to create a compulsion loop that keeps the player engaging in the activity. The technique is referred to as the variable ratio of reinforcement (or operant conditioning). It is considered simple and powerful and is believed to be one of the reasons gambling is so addictive. This trend of operant conditioning has also led to a number of allegations that emailing possesses addictive characteristics. In fact, a new term of “emailoholics” emerged as the result of one author's studies.

### Captive Marketing and Advertising

The current disclosure creates a unique opportunity for captive marketing. For example, while the user is locked out of his phone or participating in a contest while trying access to his phone, advertisers including the retailers have a captive audience for a host of different advertising options to those familiar with the art of on-line advertising and marketing on the world wide web. In one instance, the advertiser could use a retailers name in the form of the various questions, such as if one mocha from a Retailer costs $2.00 and a customer purchases five mochas, how much will the customer spend is an example of a question. Alternatively, if the Retailer's rewards card has $50.00 credit and a customer spends $17.50 what is the balance on the rewards card is another example of a question.

A critical feature of the locking mechanisms is the creation of a unique opportunity for targeted marketing that is used directly or indirectly with education, instruction or contest material. In such a case, advertisers would compensate the hosting cloud (or network) who is coordinating the introduction of the marketing material into the education content directly (or any parties working indirectly together or in combinations) as part of the question or as a separate advertisement. In yet another embodiment of the disclosure the separate advertisement may be accessible directly or only after another question or series of questions is generated on the display of the electronic device. Further still, the advertisers could rely on the nature of the content of the questions for the demographics of the targeted end user providing both a captive audience in combination with a demographically focused end user or group of end users. This example of a system and method of captive marketing and advertising is not limited to only these examples rather it is illustrative of one aspect of the current disclosure. The captive marketing mechanism could be integrated into each of the examples and illustrations included herein by one familiar with the relevant art.

In such a case, advertisers would compensate a hosting software who is coordinating the introduction of the marketing material into the education content directly as part of the question or as a separate advertisement. In yet another embodiment of the disclosure the separate advertisement may be accessible directly or only after another question or series of questions is generated. Further still, the advertisers could rely on the nature of the content of the questions for the demographic of the targeted user providing both a captive audience along with a demographically focused. This discussion of captive marketing in not limited to these examples rather it is illustrative of one aspect of the current disclosure.

In another embodiment of the rewards feature to this investment, the reward feature is further exemplified and enhanced by the type of reward trigger, the reward types, the rewards redemption, reward gamesmanship, and reward providers. Below are specific examples of each and demonstrate the various types of individual activities that one familiar with the art could incorporate.

Rewards Triggers include: check-in at certain places such as school, third-party school reporting, extracurricular conditions/goals, completion of chores, school attendance, homework completion, direct teacher third party reporting, API to teacher server for tracking grades, API to school hosting server, accomplishing specified blocks of educational content, exposure to certain blocks/time periods of learning content (video, audio, ebook), incentives for study groups/studying content together with device users, group contests, educational content, extracurriculars—outside contests that specify device user(s) as meeting, criteria, and allot those rewards to qualifying user id's for redemption.

Rewards Types include: Cumulative allowance credit, activated in portions for continued performance of criteria rules, Periodic allowance credit activated periodically for fulfilling minimum conditions, Third Party bestowal and third party can immediately bestow through portal for arbitrary things (mowing lawn, polite behavior, etc.).

Rewards Redemption include: partnership with Square and/or other mobile payment apps/companies, partnership with credit card company—puts money right on a debit card credits stored as data which work toward participating partner programs, partnerships with vendors/sponsors, and programs/contests at school or other third parties

Rewards Gamesmanship include: students can double down (or specified extra reward) with rewards by completing extra credit education content, students can risk losing x and stand to gain y, by attempting harder extra credit, question(s) which proved an A+ level of excellence in learning the material, a special Third Party at any “real life” gamesmanship can be designated to be, the “decider” of an award or contest, for example, for a sprint, or a talent, show, and immediately bestow the award to the user via their user id to a portal or directly using his device and the user's device through application on each device using NFC or QR code or what not

Rewards Providers include: Vendors, Schools/institutions and Third Party (parent)—selects a goal such as bicycle, wherein transaction using THEIR credit card gets unlocked by meeting rewards triggers/criteria. One familiar with the art would understand how these can be incorporated into the various reward features illustrated elsewhere in this document,

### Toys and Other Devices

The Educational software or modules of the present disclosure may also be used in conjunction with existing interactive toys and robots. For standalone toys and robots, and other electronic computing devices that are not connected to a network, the educational software is installed on the device, toy, or robot and coded to be compatible with the specific device and any other computer software associated with it. As a result, the user would have to successfully execute the testing modules of the present disclosure in order to gain access to the device, toy, or robot. And for interactive toys, robots, and other electronic computing devices connected to a network, the Educational software is downloaded to the device, toy, or robot, or accessible via the Question & Answer (Q & A) system server; and is coded to be compatible with the specific device, toy, or robot and any other software associated with it (e.g. toy mobile app).

### Special Needs Population

It is also noted that the present disclosure is suitable for use in a variety of situations beyond parent/child and teacher/student, such as by employers training employees, clinicians engaging in rehabilitation of patients who are mentally impaired, etc. For example a child with autism could be provided with educational content on basic hygiene routines, while an adult with Alzheimer's could be provided with education content on family history. The present disclosure may also be self-monitored learning by an individual who has elected to master a new subject (e.g. foreign language) or exercise their intellect (e.g. memory and analytical exercises for an aging individual). In this scenario, the individual would function as both the system “user” and “third party” by selecting the scope of access denied to the device, such as the entire device or the Internet, or the Facebook® website, etc.; and being provided the analyzed results of their progress directly from the system server.

In another example the electronic device could be used for monitoring the movement via a range of electronic devices such as a smart phone, smart watch or smart glasses. A movement in a targeted motion or position that is part of a learning or training program would be rewarded by providing expanded or full functionality of targeted electronic device(s).

Notwithstanding the examples and references with an emphasis on educational learning, the system and method of the present disclosure are of particular relevance to other learning applications and conditions or third-party controlled instructions or requests such as, but not limited to, those in medical rehabilitation, hospital patients, special needs children, employee, professional groups (such as accountants, doctors, and lawyers who require annual continued professional credits), specialized training courses, athletic training, physical education, military training, trivia, pre-natal care, emergency response, farming basics, sanitation and infectious disease prevention, domestic violence awareness, and so forth.

As a particular example using a patient reducing brain deterioration with customized mental exercises: A medical-dementia patient elects to use the network as a gateway where for example she informs ATT to enable only enable her critical communications including television satellite until after she achieves specific targets on brain exercises. She selects the education venue so that she could identify the precise elements of her brain between cognitive and pattern recognition that were further diminished. These areas then become the priority in her daily exercises. For her reward, she selects retail such as a meal at Denny's restaurant (including senior citizen discount for mental game progress)

### Optical Scan Analysis

In another instance of analytical mechanisms, an optical tracking software such as the programs created by Tobiis or that made available with Android 4.2 can provide further enhancements. The optical tracking software can be incorporated into the analytical process by which a learner is engaged in the series of questions or instructions. For example, an important analytical component could include the amount of time that the users eyes were focused on particular questions and answers. When compared to the time to answer the question the tracking of the eye over the questions or instructions would provide valuable analytical information to those familiar with the art of teaching and learning including adaptive learning. In one of many examples known to those in the art, reading speed would be a great practice with an eye tracking mechanism.

### Facial Recognition

In yet another instance of analytical mechanisms, facial recognition software such as programs created to track the “face print” can be incorporated into the analytical process by which a learner is engaged in a series of questions or instructions. For example, a “face print” is a series of various relative positions of various data points on a given face (e.g. nose, eyes, lips, eye brows, etc.) these different data points can be used to determine not only the face print (or the person to whom the face belongs) but the individual data points can also reveal the mood of the face (happy, sad, angry). When compared to the time to answer a question or the level of difficulty (including type of question) the tracking of the facial expression of mood would provide valuate analytical information to those familiar with the art of teaching and learing including adaptive learning. In one of many examples known to those in the level of difficulty to a question could be changed before the student even answered the question. In other words, instead of waiting for the student to submit an incorrect answer before changing the level of difficulty an adaptive program could change the reduce the level of difficulty as the expressions become more frustrated (frown) or increase the level of difficulty as the expressions become more excited (smile or laugh gesture).

### Multi-Layered Lock

The Multi-Layered Education Lock System Server comprises: a network card or other device for connecting to the Network; a memory unit comprising random access memory (RAM) for program execution, flash memory, and hard disc drive and storing the—Layered Education Lock software of the present disclosure; a central processing unit (CPU or “processor”) executing the testing software, analyzing the test results and generating reports on the user's testing trends and performance. The system further comprises a system database storing records of the user's and third party's account activity. Users' records may comprise, for example: the user's date, time, GPS location, and number of attempts to access the device; as well as reports on test results comprising trends and other analysis. Third parties' records may comprise a history of the electronic communications sent to the third party to report on the user associated with a third party's account. It is further noted that the system server may be maintained by a commercial entity that is contracted with the network service provider of the user's electronic computing device (e.g. Verizon, AT&T, etc.), that allows the entity to control the locking/unlocking of the device. Or, the system server may be part of the network service provider's operation. In one situation, the GPS system could be used to create an automatic over ride of the blocking system when the device goes beyond a specific set of coordinates. Alternatively, the act of extending beyond a set perimeter could lead to additional questions. For example, a parent may create an additional feature in their child's locking system that if at any time the child's device extends past a particular neighborhood the accessibility of the phone is blocked regardless of the child's status under any learning module until they return to the neighborhood. In another example, the child could have his phone blocked and it could be reinstated with an additional level of questions.

### Wearable Smart Devices

Wearable smart devices, in simple terms, are attempts to free data (and other calculating aspects like movement, environmental measurements, calorie consumption, calories burned bio-monitoring, etc.) from desktop computers and portable devices. More specific examples include devices that tracks steps (and stairs) as well as sleep with a vibrating alarm, including an “optimal” wake-up window, that analyzes motion so one can be waken up during the lighter portions of his sleep cycle rather than jarring him awake in the middle of deep sleep. Many are designed to have Bluetooth, WiFi and GPS built in. This enables the devices to be used as standalone smart device or in combination with another smart device such as a phone, tablet, etc.

There are about a different companies that have already emerged with different versions of wearable smart devices and they include: Fitbit, Google Glass, Samsung Galaxy Gear, GreenPeek, GSMA, IvenSense, Lumus, Motorola Solutions, Nike+ and Fuel Band, Vuzix and Withings.

Notable examples of commercial items that one familiar with the art would realize could be interchangeable with the traditional smart devices used such as phone, tablet, game counsel, smart tv, automobile include the products from Fitbit and Google.

Fitbit offers several different products that include: Flex™ wireless sleep and activity tracker bracelet that tracks movement, calories consumed, sleeping, etc., Zip™ wireless activity tracker a clip on device that tracks steps, distance, calories burned, stairs climbed and sleep, Aria™ wifi weight scale (a standard home use scale configuration) that tracks weight, body mass index. Each of these devices and all of the information are sent via number of electronic methods where the information is tracked and summarized on the cloud or personal electronic device. Fitbit also offers an open API so many of the data captures can be shared and included with developments and applications.

Essentially, Google Glass is a camera, display, touchpad, battery and microphone built into spectacle frames so that you can perch a display in your field of vision, film, take pictures, search and translate on the go to name a few features. Bluetooth and WiFi will be built in.

### “Smart” Systems for Automobiles

“Smart” car systems such as those offered by Ford's Synch program include a range features that can be synchronized. To power Sync, Ford powered with Microsoft for the software. Microsoft created Microsoft Auto software, which can interface with just about any current MP3 player or Bluetooth cell phone. Passengers can connect their cell phones through Sync's integrated Bluetooth technology. The software will seek the address book and transfer the names and numbers to an internal database. Like many existing Bluetooth cell phone links, Sync is capable of voice-activated, hands-free calling. Push a button on the steering wheel, and you can speak the name or number you wish to call.

Sync diverts from the traditional Bluetooth path by utilizing text-to-speech technology to read aloud any text messages you might receive while driving. The system can translate commonly used text message phrases such as “LOL” (laughing out loud). In turn, you can reply to an audible text message from one of 20 predefined responses. Sync also supports many of the other features found on cell phones, including caller ID, call waiting, conference calling, a caller log, and signal strength and battery charge icons. When you receive a call, Sync can play personal ring tones, including special tones for specific callers. All this information is shown on the radio display screen.

As Sync primarily runs on software, the system is upgradeable. Ford and Microsoft have plans to allow dealer service technicians to perform updates when the vehicles are in for scheduled maintenance. Updates may also be available on a Web-site for consumers to download and install.

Since the introduction of Sync in the 2008 model year, other car makers have launched similar systems. GM has expanded its OnStar service and integrated Sync-like features into its infotainment system, and has even added smartphone apps so drivers can do things like unlock and start their cars remotely. Hyundai is launching its Bluelink service on some 2012 models. Bluelink not only has things like vehicle tracing and crash notifications services, but also includes features like Bluetooth integration, and location services that allow your car to check in at various locations—something that's helpful if you're a social media fanatic.

The current disclosure can be integrated into these “smart” features in the car and will thusly disable the features in the car directly through the target electronic devices or into the separate software of the vehicle using API or other means well known to those in the art.

### CONCLUSION

Aspects of the present disclosure are described above with reference to flowchart illustrations and/or block diagrams of methods, apparatus (systems and devices—smartphones, desktops, etc.) and computer program products according to embodiments of the disclosure including those applied to iOS based devices as well as those described as Further Examples of Optional Features with Current Invention Sound Level Control. It will be understood that each block of the flowchart illustrations and/or block diagrams, and combinations of blocks in the flowchart illustrations and/or block diagrams in addition with the “optional features”, can be implemented by computer program instructions to incorporate the body of this disclosure namely the locking and unlocking mechanisms for usage. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. One familiar with the individual elements of the “optional features” and combinations would be possess sufficient knowledge for complete integration for any combinations.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the disclosures. The various appearances of “one embodiment,” “an embodiment” or “some embodiments” do not necessarily all refer to the same embodiments.

Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the disclosures.

In the foregoing, reference is made to student or trainee; however, is to be understood that the phraseology and terminology employed herein is not to be construed as limiting and are for descriptive purpose only.

It is to be understood that the details set forth herein do not construe a limitation to an application of the disclosure.

Furthermore, it is to be understood that the disclosure can be carried out or practiced in various ways and that the disclosure can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

I/We claim:

1. A computerized method for locking and overriding the lock to designated features on a user electronic device, comprising:
receiving a request to lock a user electronic device to prevent access to designated device features, wherein the request to lock the user electronic device is manually inputted into the user electronic device, or transmitted from the third party electronic device to the user electronic device via a network, or whenever the user electronic device is powered up, restarted or comes out of sleep mode;
locking the designated device features;
receiving input from a third party or the user to override the lock on the device;
unlocking the designated device features; and,
transmitting an electronic message to the third party electronic device that the user has overridden the lock.

2. The method of claim 1, wherein the designated device features comprise one or more of Internet, email, instant messaging, text messaging, and selected software installed on the user electronic device.

3. The method of claim 1, wherein the request to override the lock is input via keystroke, touch input to a touch screen, or audio message into the user electronic device, or remotely via a network.

4. The method of claim 3, wherein the input is a code designated by the user or third party and stored in an account on a system server, or it may be a universal code for all users of the system.

5. The method of claim 1, wherein all of a user electronic devices connected to an internet comprising laptops, desktops, tablets, cell phones, smart phones, game consoles, automobile ignitions, are locked and unlocked simultaneously.

6. The method of claim 1, wherein a gateway server that runs on or is connected to a cloud-computing platform locks and unlocks the user electronic device while in electronic communication with a native application installed on the user electronic device.

7. The method of claim 1, wherein the user may override the lock to call 911 or emergency contacts.

8. A computerized method for locking and unlocking designated features on a user electronic device, comprising:
receiving a request to lock a user electronic device to prevent access to designated device features, wherein the request to lock the user electronic device is manually inputted into the user electronic device, or transmitted from the third party electronic device to the user electronic device via a network, or whenever the device is powered up, restarted or comes out of sleep mode;
locking the designated device features;
receiving input to unlock the designated device features on the device based on occurrence of a condition, wherein the condition comprises successful completion of a task by the user, passage of preset time duration or at time of day, and detection of global positioning system (GPS) coordinates of device within a designated location; and,
unlocking the designated device features when verification of the condition occurs.

9. The method of claim 8, further comprising a third party selecting the occurrence of a condition.

10. The method of claim 9, wherein the third party is a parent or teacher, and the user is a child and the task comprises one or more of: completion of a household chore, correct completion of an academic exercise, school attendance, conduct, and academic test score.

11. The method of claim 9, wherein the third party is an employer and the user is an employee and the task comprises one or more of: successful completion of an assigned job, performance, attendance, and an academic exercise.

12. The method of claim 11, further comprising transmitting an electronic message to the third party electronic device that the condition has been successfully met and the device is unlocked.

13. The method of claim 8, wherein the task comprises displaying questions and receiving user's answers via user input on a graphical user interface of the user electronic device.

14. The method of claim 8, wherein all of a user electronic devices connected to an internet comprising laptops, desktops, tablets, cell phones, smart phones, game consoles, automobile ignitions are locked and unlocked simultaneously.

15. The method of claim 8, wherein a request to lock and unlock the user electronic device is input via keystroke, touch input to a touch screen, or audio message into the user electronic device, or remotely via a network.

16. The method of claim 8, further comprising the user receiving a reward for successful completion of the task, wherein the reward is provided by the third party, a retailer, a financial institution, or educational institution.

17. A computerized method for locking and unlocking designated features on a user electronic device utilizing a randomly generated passcode, comprising:
receiving a request from a third party to lock a user electronic device to prevent access to designated device features while maintaining access to target applications for a user to perform selected activities;
receiving input on one or more objectives for the select activity to be achieved by the user as a condition to unlock the user electronic device;
generating a randomly generated passcode to lock the user electronic device designated features while maintaining access to target applications;
receiving the generated passcode input from the third party and locking the designated device features;
receiving input from the user within the target applications in executing the selected activity;
when the user achieves the objectives, displaying the passcode on the user electronic device; and,
unlocking the designated features on the user electronic device in response to passcode input by the user.

18. The method of claim 17, wherein the selected activities comprise one or more of learning exercises, physical exercises, assigned tasks or duties, and time management exercises.

19. The method of claim 17, wherein the target applications comprise non-transitory computer-readable medium having non-transitory computer-readable instructions stored therein, the non-transitory computer-readable instructions being capable of instructing the device to perform methods related to displaying user instructions on the user electronic device graphical interface and computing objective achievement for the selected activities.

20. The method of claim 17, wherein the features comprise one or more of Internet browsing, specific Internet websites, email, instant messaging, text messaging, and selected software installed on or accessible from the user electronic device.
